(19) United States
(12) Patent Application Publication
(10) Pub. No.: US 2011/0167727 A1
(43) Pub. Date: Jul. 14, 2011

(54) GATE APPARATUS

(75) Inventors: Yojiro Kamise, Hyogo (JP); Hirofumi Kameyama, Hyogo (JP); Takeshi Nakamura, Hyogo (JP); Mitsunori Yokota, Hyogo (JP); Toshiyuki Yoshida, Hyogo (JP); Hidenori Yamamoto, Hyogo (JP)

(73) Assignee: GLORY LTD., Himeji-shi, Hyogo (JP)

(21) Appl. No.: 12/735,870

(22) PCT Filed: Feb. 17, 2009
(86) PCT No.: PCT/JP2009/000640

§ 371 Date: Aug. 23, 2010

(30) Foreign Application Priority Data
Feb. 22, 2008 (JP) 2008-042256
Feb. 22, 2008 (JP) 2008-042257
Feb. 22, 2008 (JP) 2008-042258

(51) Int. Cl. E06B 7/00

(52) U.S. Cl. 49/70

(57) ABSTRACT

A gate apparatus identifies whether a person is authorized to pass through, and allows the identified person to pass through. The gate apparatus obtains information about a shape of the person who is allowed to pass through. The gate apparatus restricts at least frontward and rearward travel of the person traveling from an entrance to an exit of a passageway in the gate apparatus to form space defined within the passageway, and is capable of adjusting a shape of the defined space based on the obtained shape information of the individual person.

### TECHNICAL FIELD

A technology disclosed in this specification relates to a gate apparatus placed at an entrance of buildings and plants, an entrance of a certain room in a building, or a security gate at stations and airports, particularly to a gate apparatus which prevents tailgating, and allows individual passage of identified persons only.

### BACKGROUND ART

A gate apparatus which allows individual passage of identified persons only has been known. In this gate apparatus, for example, an entrance flap and an exit flap are arranged in a passageway in the gate apparatus in such a manner that the flaps rotate in the direction along the passageway about the same rotation axis, thereby opening and closing the passageway. Sensors for detecting passage of a person are arranged near the entrance and near the exit, respectively, and an identification section is provided within the passageway. In a normal state, the exit flap is in a closed position, i.e., is substantially perpendicular to the passageway, and the entrance flap is in an opened position, i.e., is substantially parallel to the passageway. That is, the flaps are arranged substantially in the shape of L, and are ready to permit entry of the person. When the person travels, the sensor near the entrance detects that the person has entered the gate apparatus. Then, when the identification section identifies that the person is authorized to pass through, the exit flap is opened, and the entrance flap is closed to keep the substantial L shape formed by the flaps on condition that the entrance sensor does not detect any person entering the passage. Thus, space for a single person is kept between the flaps until the entrance flap moves to the closed position at which entry of the next person can be prevented (see, e.g., Patent Document 1).

Patent Document 1: Japanese Patent Publication No. 2005-316787

### SUMMARY OF THE INVENTION

### Technical Problem

According to the conventional gate apparatus, however, the space formed by the flaps to allow the individual passage of the person has a fixed size. Therefore, the space may be tight for a large person, or a person carrying a bag. Further, the gate apparatus may possibly permit entry of two or more children or adults at one time if they are small or short. In general, the entrance sensor can detect simultaneous entry of two or more persons. However, the two persons may erroneously be detected as a single person when they are close to each other to pass through. Thus, the gate apparatus cannot prevent the tailgating, and cannot achieve the individual passage of the person.

### Solution to the Problem

According to the disclosed technology, space which is adjustable to the shape of the person, such as body shape, is formed in the passageway of the gate apparatus to allow only the identified persons to individually pass through, and the space necessary and sufficient for the individual person is ensured, thereby preventing the tailgating by two or more persons who attempt to simultaneously pass through.

By definition, an illegal act of allowing a person except for an identified person to pass through may be referred to as “pretending.” In this specification, the behavior will be referred to as “impersonation.”

Another illegal act of an unidentified person who follows an identified person to pass through may be referred to as “piggybacking” or “tailgating.” In this specification, the term “tailgating” will be used.

The gate apparatus identifies whether a person is authorized to pass through, and allows the identified person to pass through, and includes a shape information obtaining section which is configured to obtain information about a shape of the person who is allowed to pass through, and a restriction section which is configured to restrict at least frontward and rearward travel of the person traveling from an entrance to an exit of a passageway in the gate apparatus to form space defined within the passageway, and is capable of adjusting a shape of the defined space based on the shape information of the individual person obtained by the shape information obtaining section.

### Advantages of the Invention

According to the gate apparatus, space which is adjustable to the shape of the person, such as body shape, is formed in the passageway of the gate apparatus to allow only the identified persons to individually pass through, and the space can reliably be provided with necessary and sufficient size for the individual person, thereby preventing the tailgating by two or more persons who attempt to simultaneously pass through.

### BRIEF DESCRIPTION OF THE DRAWINGS

FIG. 1 is a perspective view of a gate apparatus according to a first embodiment.

FIG. 2 is a plan view of the gate apparatus shown in FIG. 1.

FIG. 3 includes a schematic side view (a left view), and a schematic front view (a right view) illustrating the structure of a base of a sliding shutter of the gate apparatus shown in FIG. 1.

FIG. 4 includes a schematic side view (a left view), and a schematic front view (a right view) illustrating the structure of an attachment of the sliding shutter of the gate apparatus shown in FIG. 1.

FIG. 5 is a view illustrating the internal structure of the sliding shutter of the gate apparatus shown in FIG. 1.

FIG. 6 is a schematic side view illustrating a mechanism of attaching a side panel, and a mechanism of illuminating the side panel of the gate apparatus shown in FIG. 1.

FIG. 7 is a schematic vertical cross-sectional view illustrating the mechanism of attaching the side panel, and the mechanism of illuminating the side panel of the gate apparatus shown in FIG. 1.

FIG. 8 is a schematic side view illustrating a mechanism of attaching an exit door, and a mechanism of illuminating the exit door of the gate apparatus shown in FIG. 1.

FIG. 9 is a schematic lateral cross-sectional view illustrating the mechanism of attaching the exit door, and the mechanism of illuminating the exit door of the gate apparatus shown in FIG. 1.

FIG. 10 is a view illustrating the arrangement of passage detection sensors of the gate apparatus shown in FIG. 1.

FIG. 11 is a diagram of a control block of the gate apparatus shown in FIG. 1.

FIG. 12 is a flow diagram illustrating a control procedure of the gate apparatus shown in FIG. 1.

FIG. 13 is a view illustrating the operation of the gate apparatus shown in FIG. 1 when the passage is allowed.

FIG. 14 is a view illustrating the operation of the gate apparatus shown in FIG. 1 when the passage is not allowed.

FIG. 15 is a view illustrating the operation of the gate apparatus shown in FIG. 1 when a wheelchair passes through.

FIG. 16A is a comparative view illustrating the operation of the gate apparatus shown in FIG. 1 according to a first operation example.

FIG. 16B is a view illustrating the operation of the gate apparatus shown in FIG. 1 according to the first operation example.

FIG. 17 is a view illustrating the operation of the gate apparatus shown in FIG. 1 according to a second operation example.

FIG. 18 is a view illustrating the operation of the gate apparatus shown in FIG. 1 according to a third operation example.

FIG. 19A is a comparative view for illustrating the operation of the gate apparatus shown in FIG. 1 according to a fourth operation example.

FIG. 19B is a view illustrating the operation of the gate apparatus shown in FIG. 1 according to the fourth operation example.

FIG. 20 is a view illustrating the structure and operation of a first alternative example of the gate apparatus of the first embodiment.

FIG. 21 is a view illustrating the structure and operation of another alternative example of the gate apparatus of the first embodiment.

FIG. 22 is a view illustrating the structure and operation of still another alternative example of the gate apparatus of the first embodiment.

FIG. 23 is a plan view illustrating a gate apparatus of a second embodiment.

FIG. 24 is a diagram of a control block of the gate apparatus shown in FIG. 23.

FIG. 25 is a view illustrating a first installation example of the gate apparatus shown in FIG. 23.

FIG. 26 is a flow diagram illustrating a control procedure according to the first operation example of the gate apparatus shown in FIG. 23 installed according to the first installation example.

FIG. 27 is a view illustrating the operation according to the first operation example of the gate apparatus shown in FIG. 23 installed according to the first installation example.

FIG. 28 is a flow diagram illustrating a control procedure according to a second operation example of the gate apparatus shown in FIG. 23 installed according to the first installation example.

FIG. 29 is a view illustrating the operation according to the second operation example of the gate apparatus shown in FIG. 23 installed according to the first installation example, in which passage is allowed.

FIG. 30 is a view illustrating the operation according to the second operation example of the gate apparatus shown in FIG. 23 installed according to the first installation example, in which passage is not allowed.

FIG. 31 is a view illustrating a second installation example of the gate apparatus shown in FIG. 23.

FIG. 32 is a view illustrating a third installation example of the gate apparatus shown in FIG. 23.

### DESCRIPTION OF REFERENCE CHARACTERS

1 Gate apparatus
2 Left body
3 Right body
6 Side panel
7 Exit door
8 Entrance identification section (first identification section, shape information obtaining section)
9 Camera (second identification section)
10 Open/close member
10a-10h First to eighth sliding shutters
11 Passage detection sensor
11a-11g First to seventh passage detection sensors
12 Camera (palmprint sensor)
13 Camera
26a, 26b, 26c, 26d Link
42 Light emitting member
47 Light emitting member
50 Wheelchair sensor
51 Exit sensor
60 Control section

### DESCRIPTION OF EMBODIMENTS

An example gate apparatus is a gate apparatus which identifies whether a person is authorized to pass through, and allows the identified person to pass through, and includes a shape information obtaining section which is configured to obtain information about a shape of the person who is allowed to pass through, and a restriction section which is configured to restrict at least frontward and rearward travel of the person traveling from an entrance to an exit of a passageway in the gate apparatus to form space defined within the passageway, and is capable of adjusting a shape of the defined space based on the shape information of the individual person obtained by the shape information obtaining section. The information about the shape of the person includes physical (body shape) information such as the person's height, shoulder width, hip width, etc. However, when the person carries a bag etc., the information may include information about the shape of the person and the bag.

In this gate apparatus, the restriction section restricts at least forward and rearward travel of the person traveling from the entrance to the exit of the passageway in the gate apparatus to form space defined within the passageway, thereby allowing individual passage of the identified person only. In particular, the shape of the defined space is adjustable based on the shape information of the individual person. Thus, the defined space can reliably be provided with necessary and sufficient size for the shape of the person, such as the body shape. This would not give the person a feeling of being cramped, and can prevent tailgating by two or more persons who attempt to simultaneously pass through.

The restriction section is capable of adjusting a lateral dimension of the defined space orthogonal to the traveling direction of the person, and is capable of adjusting the shape of the defined space by adjusting the lateral dimension. This allows adjustment of the lateral dimension of the defined space in accordance with the person's shoulder width, or the person's lateral width including his/her bag. This would not give the person a feeling of being cramped, and can reliably prevent the tailgating by people traveling side by side.

The restriction section is capable of adjusting a front-back dimension of the defined space parallel to the traveling direction of the person, and is capable of adjusting the shape of the defined space by adjusting the front-back dimension. This allows adjustment of the front-back dimension of the defined space in accordance with a thickness of the person's chest, or a thickness of the person including his/her bag. This would not give the person a feeling of being cramped, and can reliably prevent the tailgating by people traveling in line in the front-back direction.

The restriction section is preferably capable of moving the defined space in the traveling direction of the person while substantially keeping the shape of the defined space determined based on the shape information of the individual person. Thus, the person can smoothly be guided to the exit by moving the defined space while substantially keeping the shape of the defined space.

The restriction section may include three or more open/close members which are arranged along the passageway, and slide across the passageway to open/close the passageway, and may be capable of changing the shape of the defined space by adjusting the degrees of opening of the open/close members. Thus, the shape of the defined space can be changed in the lateral or front-back direction by adjusting the degrees of opening of the three or more open/close members which are arranged along the passageway, and slide across the passageway to open/close the passageway.

The restriction section may include four or more open/close members which are arranged along the passageway, and slide across the passageway to open/close the passageway, and may be capable of changing the shape of the defined space by adjusting the degrees of opening of the open/close members located in the middle of the passageway in the traveling direction of the person. Thus, the shape of the defined space can be changed in both the lateral and front-back directions by adjusting the degrees of opening of the open/close members located in the middle of the passageway in the person's traveling direction.

The restriction section including the four or more open/close members which are arranged along the passageway, and slide across the passageway to open/close the passageway is capable of moving the defined space in the traveling direction of the person by sequentially opening/closing the open/close members arranged along the passageway. Thus, the person can smoothly be guided to the exit by moving the defined space in the person's traveling direction by sequentially opening and closing the open/close members.

According to a known example of the gate apparatus which allows only an identified person to pass through, a first ID checker is arranged at an entrance of a revolving door, and a second ID checker is arranged inside the revolving door. A person identified by the first ID checker is allowed to enter the revolving door, and is re-identified in closed space inside the revolving door by the second ID checker. This can prevent “impersonation,” i.e., passage of a person except for the person identified by the first ID checker (see, e.g., Publication of Examined Japanese Patent Application No. H04-37908). According to another example, cameras for checking iris data are arranged at an entrance and inside of a check area. When a person is identified as a registered person by the identification at the entrance, a gate at the entrance is opened. In the check area, where many people can enter at one time, iris identification is performed on every person. When at least one of the people in the check area is found unregistered, a gate at the exit of the check area is not opened (see, e.g., Japanese Patent Publication No. H11-185087).

According to the example of the gate apparatus in which the person is identified by the first ID checker at the entrance of the revolving door, and is re-identified by the second ID checker inside the revolving door, the revolving door has to be stopped until the first authorization at the entrance is completed. Further, the revolving door has to be stopped also for the authorization inside the revolving door by the second ID checker while the person is temporarily confined inside the revolving door. This interrupts the flow of people, and is not suitable for use in places where many people come and go.

According to the example of the gate apparatus in which the cameras for checking iris data are arranged at the entrance and the inside of the check area in such a manner that the gate at the entrance is opened after the identification at the entrance, and the gate at the exit is opened after the iris identification performed on every people in the check area, many people can pass through at one time, and the iris identification can be done again while the people are passing through the check area. Therefore, the flow of people is not interrupted. In this case, however, when many people travel in line, for example, a person behind another person may be hidden from the camera, and may not be identified correctly. Thus, the illegal passage by “impersonation” cannot be found at once, and cannot be prevented.

A technology disclosed in this specification can reliably prevent illegal passage by “impersonation” without interrupting the flow of people for the identification in the gate apparatus.

The example gate apparatus identifies whether a person is authorized to pass through, and allows the identified person to pass through. The gate apparatus includes: a restriction section which is configured to restrict at least forward and rearward travel of the person traveling from an entrance to an exit of a passageway in the gate apparatus to form space defined within the passageway, and is capable of moving the defined space in the person's traveling direction; a first identification section which is configured to identify the person before entering the defined space; and a second identification section which is configured to identify the person who is traveling the passageway in accordance with the movement of the defined space.

According to the gate apparatus, the restriction section restricts at least forward and rearward travel of the person traveling from the entrance to the exit of the passageway in the gate apparatus to form space defined within the passageway. This allows individual passage of the identified person only. In particular, the person is identified before entering the defined space, and is re-identified when the person is traveling the passageway in accordance with the movement of the defined space. Thus, illegal passage by the so-called “impersonation” can reliably be prevented without interrupting the flow of people.

The gate apparatus further includes a shape information obtaining section which is configured to obtain information about shape of the person who is allowed to pass through, and an adjustment section which is configured to adjust the shape of the defined space by driving and controlling the restriction section based on the shape information of the individual person obtained by the shape information obtaining section. The information about the shape of the person includes physical (body shape) information such as the person's height, shoulder width, hip width, etc. However, when the person carries a bag etc., the shape information may include information about the shape of the person and the bag.

With the provision of the shape information obtaining section and the adjustment section, the shape of the defined space can be adjusted based on the shape information of the individual person. This allows keeping the defined space of necessary and sufficient size for the shape of the person, such as body shape, thereby allowing individual passage of the person.

The restriction section includes three or more open/close members which are arranged along the passageway, and slide across the passageway to open/close the passageway. The restriction section is capable of changing the shape of the defined space by adjusting the degrees of opening of the open/close members. Thus, the shape of the defined space can be changed at least in the lateral direction by adjusting the degrees of opening of the three or more open/close members which are arranged along the passageway, and slide across the passageway to open/close the passageway.

In the gate apparatus, the second identification section comprises an imaging section which takes an image of the traveling person. The restriction section is preferably configured to incline at least part of a movement path of the defined space toward a direction away from the imaging section relative to a direction parallel to sidewalls of the passageway. With this configuration, when two persons attempt to pass through in line in a front-back direction, for example, a person behind the front person would not be hidden from the imaging section, and the person's image can be taken from an oblique direction. This allows reliable recognition of the two persons aligned in line in the front-back direction.

The second identification section preferably comprises a biometric identification section which utilizes biometric information of the person. The second identification section determines whether the person who entered the gate apparatus is identical to the person identified by the first identification section. Therefore, the second identification section preferably performs biometric identification such as face identification, like an imaging means, such as a camera etc. Authorization using a card or a pin number may allow passage of other person who borrowed the card, or obtained the pin number.

Japanese Patent Publication No. H04-43479 shows a gate apparatus described below. Specifically, as a known example of the gate apparatus which can control the person's traveling direction, for example, the publication shows a gate management system used at a lift in a ski site. A sorting gate capable of swinging to the right and left is placed at a branch point of a Y-shaped passageway, and is driven to block one of access to the lift and access to the slope. When a person who carries a mobile automatic payment device is allowed by a ticket gate to enter the Y-shaped passageway, the gate blocks the access to the slope, and allows the access to the lift, thereby allowing the person to proceed to the lift. When the person is not allowed, the gate blocks the access to the lift, and allows the access to the slope, thereby sending the person back to the slope.

In this gate apparatus, the sorting gate is placed at an exit of the gate apparatus. Thus, the person has to change the traveling direction just in front of the gate, which may interrupt smooth travel of the person. In this system, the sorting gate is located forward in the person's traveling direction, and the gate itself is generally configured simply like an automatic ticket gate at stations. Therefore, the system may possibly entice the person who is not allowed to proceed to the desired direction to manually open the gate which has blocked the access to the desired direction, or to cross over the gate. Further, the system including the sorting gate of this type merely sorts people in two directions. In order to sort people in three or more directions, for example, additional sorting gates have to be provided, thereby complicating the structure of the gate. Further, the system includes a human detection sensor in an identification area. However, when two or more persons are close to each other to pass through the area, the sensor may possibly fail to detect them. Thus, the tailgating cannot reliably be prevented.

The disclosed technology may control the traveling direction of the person in the gate apparatus to naturally guide the person to the predetermined exit position without interrupting smooth travel of the person, and may prevent the tailgating by two or more persons who attempt to enter simultaneously.

The example gate apparatus is a gate apparatus which includes an entrance and an exit, and is capable of controlling the traveling direction of the person who entered the gate apparatus from the entrance. The gate apparatus includes a restriction section which is configured to restrict lateral movement of the person traveling in the gate apparatus relative to the person's traveling direction to form a (specified) passageway extending from the entrance to a part of the exit, and an adjustment section which is configured to adjust the shape of the passageway by driving and controlling the restriction section, thereby connecting the passageway to a predetermined part of the exit.

The gate apparatus forms a passageway extending from the entrance to the part of the exit by restricting the lateral movement of the person traveling in the gate apparatus relative to the person's traveling direction, and adjusts the shape of the passageway to connect the passageway to the predetermined part of the exit. Thus, the person's traveling direction in the gate apparatus can be controlled, and the person can naturally be guided to the predetermined exit position without interrupting smooth travel of the person.

The example gate apparatus is a gate apparatus which includes an entrance and an exit, and is capable of controlling the traveling direction of the person who entered the gate apparatus from the entrance. The gate apparatus includes a restriction section which is configured to restrict an area around the person traveling the gate apparatus to form defined space, and is capable of moving the defined space from the vicinity of the entrance to the vicinity of the exit, and an adjustment section which is configured to adjust a movement path of the defined space by driving and controlling the restriction section to bring the defined space to the predetermined location near the exit.

The gate apparatus forms the defined space by restricting the area around the person traveling the gate apparatus, and adjusts the movement path of the defined space to move the defined space from the vicinity of the entrance to the predetermined location near the exit. Thus, the defined space can be used as the passageway, and the person's traveling direction in the gate apparatus can be controlled. Therefore, the person can naturally be guided to the predetermined exit position without interrupting smooth travel of the person. Further, since the defined space formed by restricting the area around the person is moved from the vicinity of the entrance to the vicinity of the exit, the “tailgating” by two or more persons who attempt to enter simultaneously can be prevented.

The restriction section includes a plurality of open/close members which are arranged along the passageway, and slide in a lateral direction relative to the traveling direction of the person traveling the gate apparatus to open/close the passageway, and forms a passageway to the predetermined region of the exit by adjusting the degrees of opening of the open/close members. With the restriction section configured in this manner, the shape of the passageway can be adjusted by adjusting the degrees of opening of the open/close members, and the passageway is connected to the predetermined region of the exit, thereby smoothly guiding the person to the exit.

The restriction section includes a plurality of open/close members which are arranged along the passageway, and slide in a lateral direction relative to the traveling direction of the person traveling the gate apparatus to open/close the passageway, and moves the defined space to the predetermined position near the exit by adjusting the degrees of opening of the open/close members. With the restriction section configured in this manner, the shape of the defined space can be changed both in the lateral and front-back directions by adjusting the degrees of opening of the open/close members, and the defined space can be moved in the traveling direction by sequentially opening/closing the open/close members, thereby smoothly guiding the person to the exit.

The gate apparatus includes an identification section which is configured to identify whether a person is authorized to pass through, and the adjustment section may drive and control the restriction section based on information from the identification section. This allows access of only the identified person to a permitted region of the exit. The gate apparatus will be described below in further detail with reference to the drawings.

### FIRST EMBODIMENT

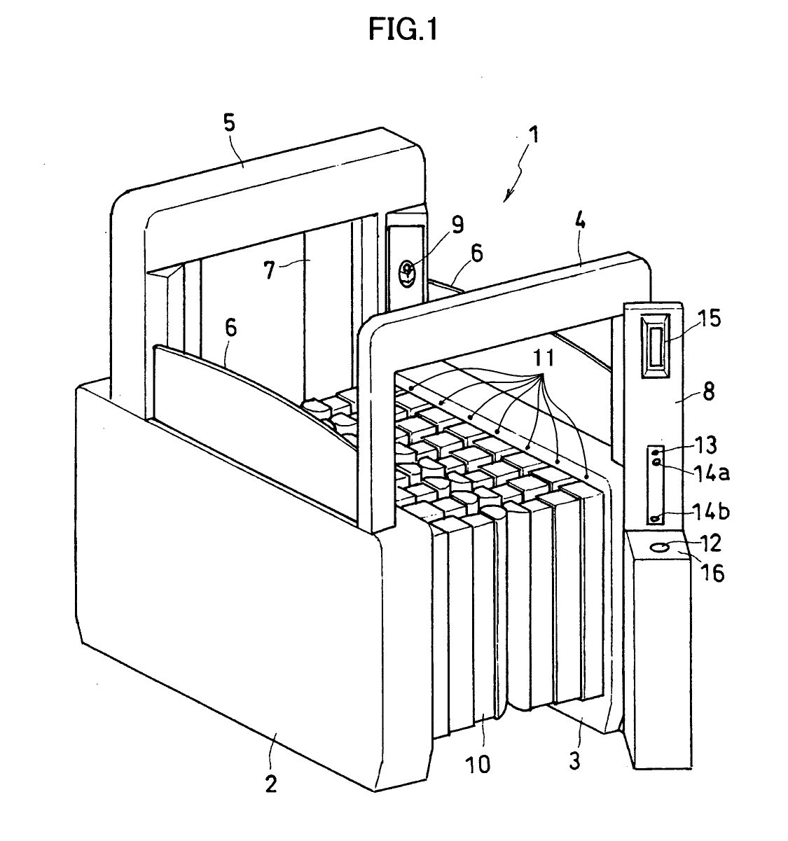

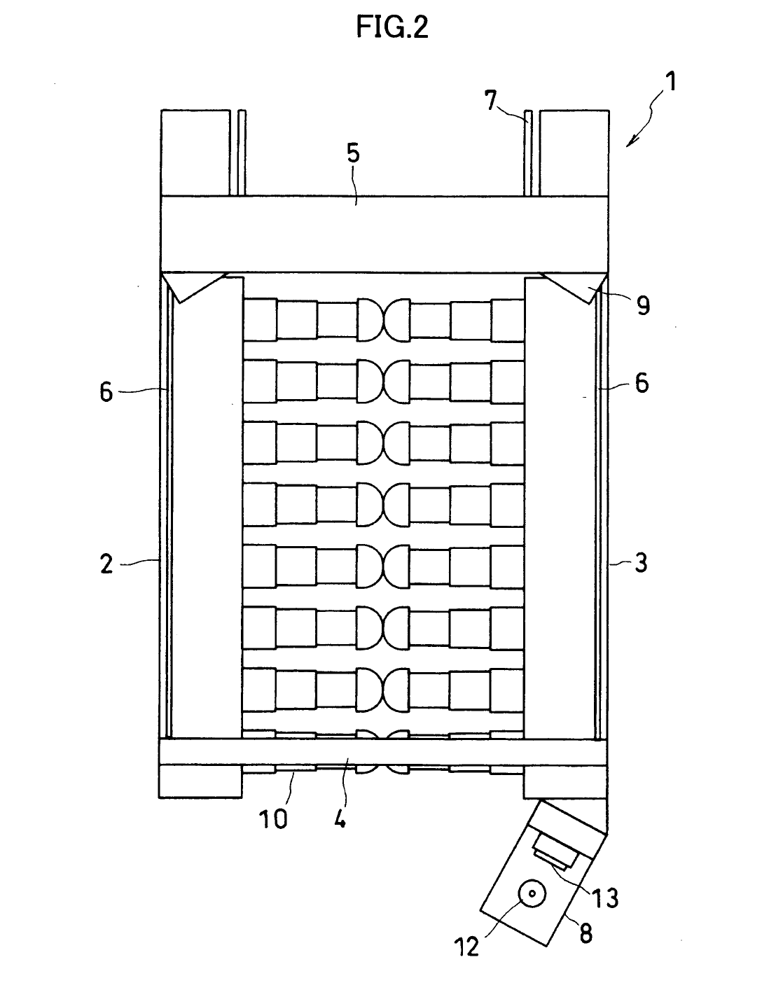

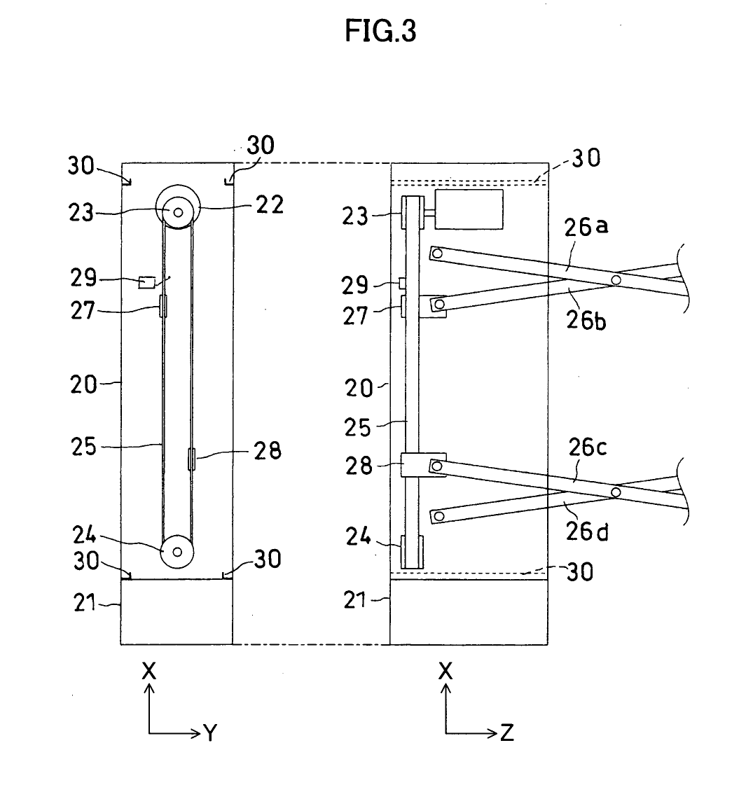

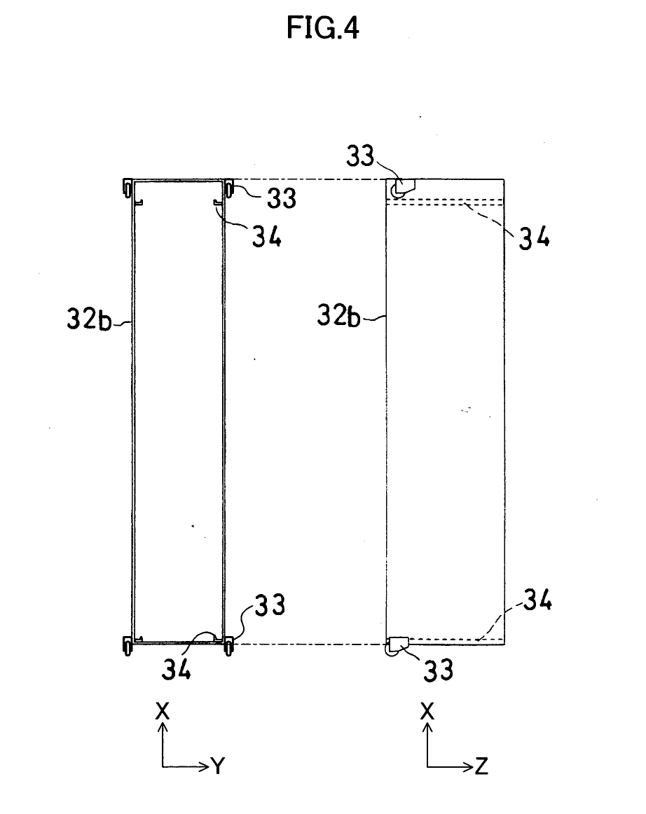

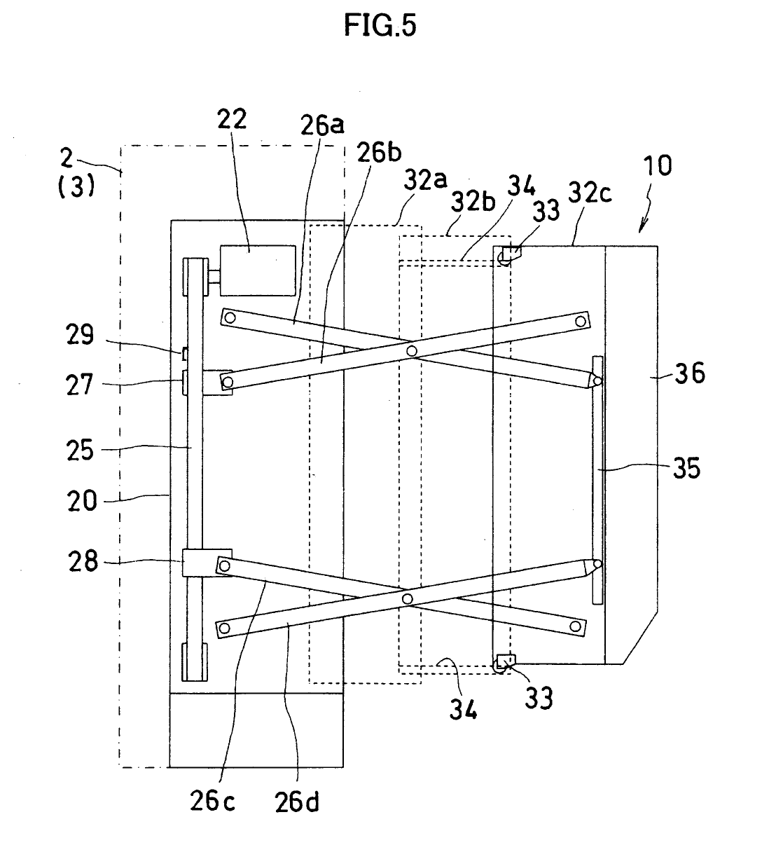

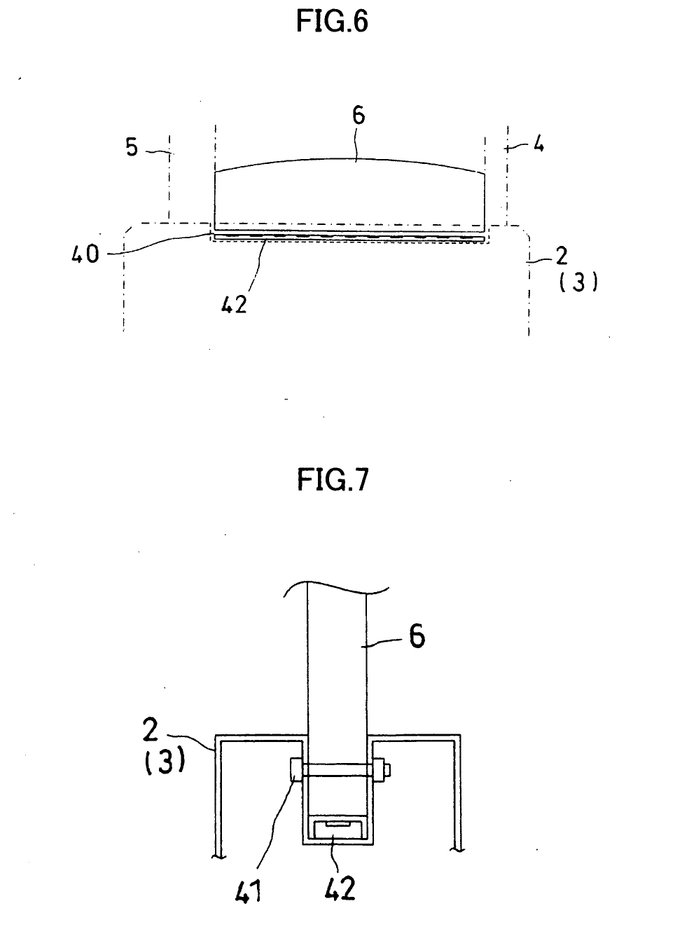

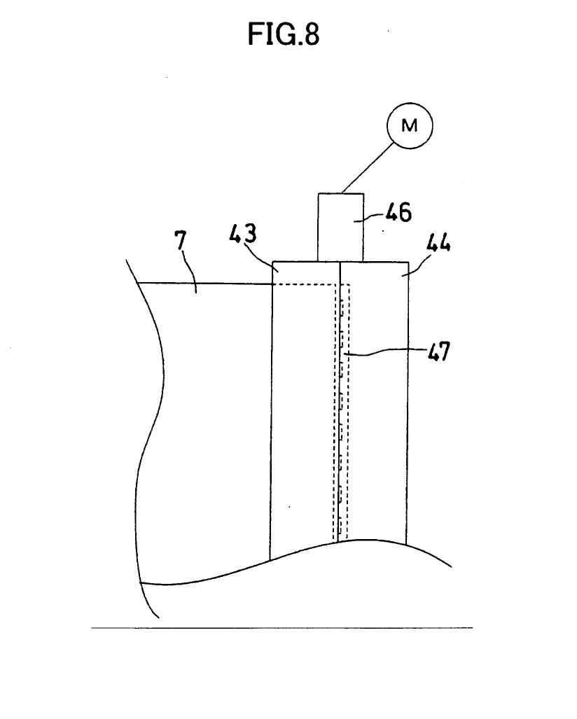

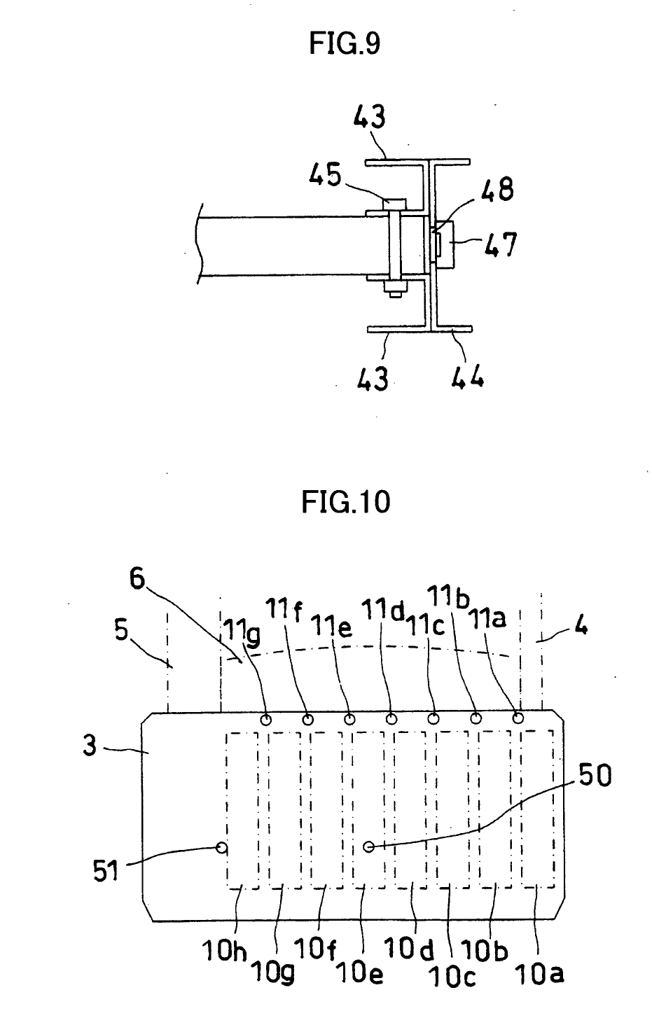

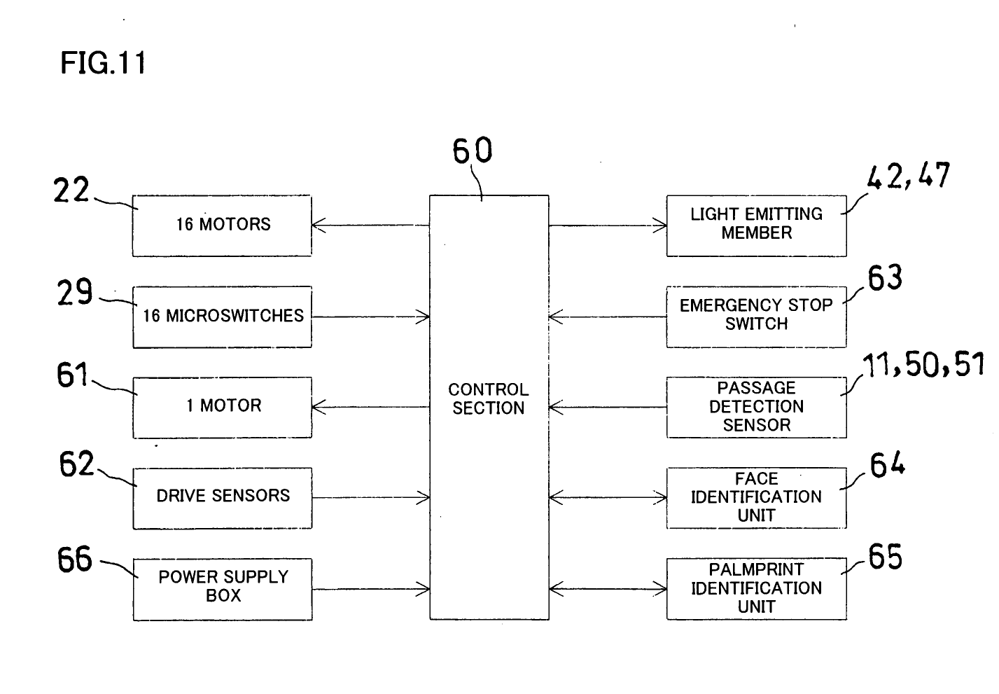

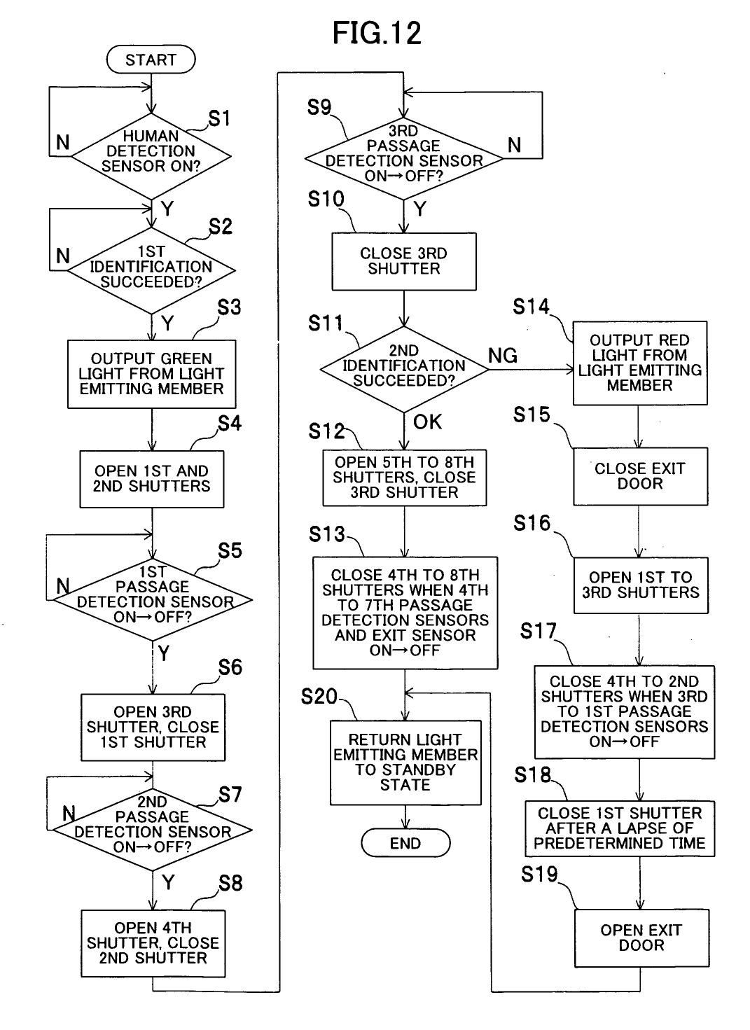

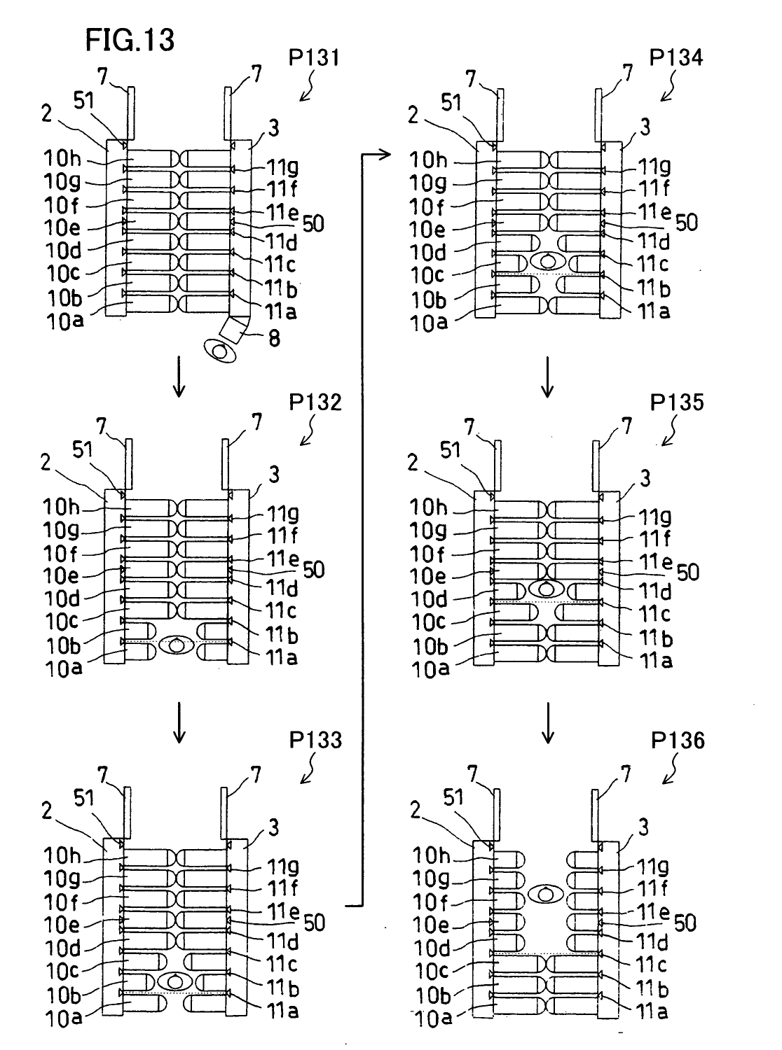

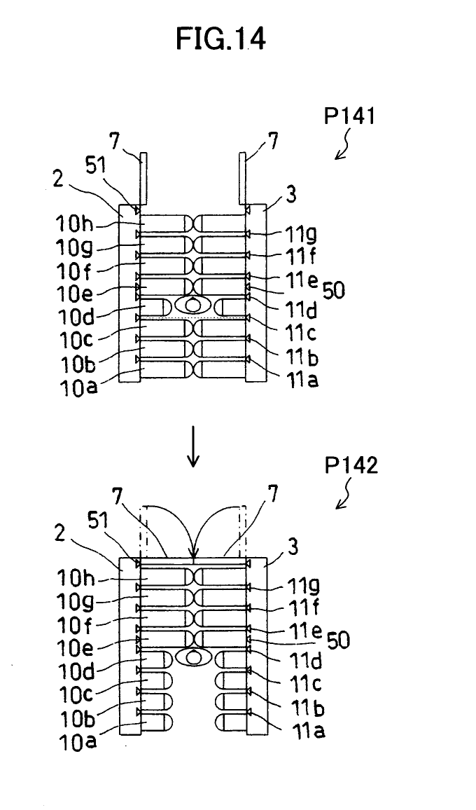

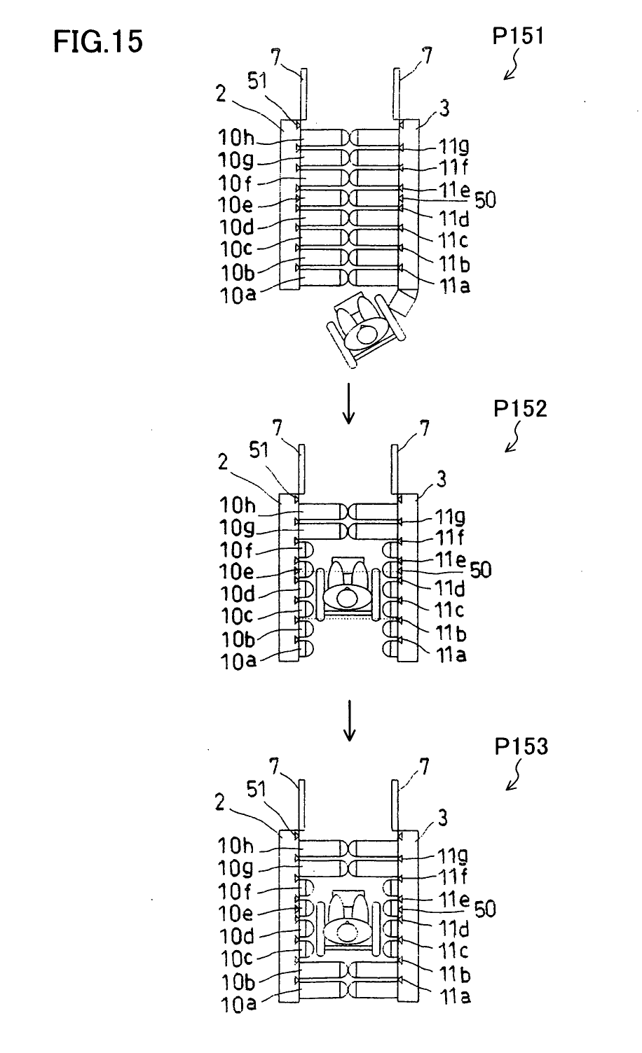

FIGS. 1 to 15 show a first embodiment of the invention. FIG. 1 is a perspective view of a gate apparatus. FIG. 2 is a plan view of the gate apparatus. FIG. 3 shows the structure of a base of a sliding shutter in a schematic side view on the left, and in a schematic front view on the right. FIG. 4 shows the structure of an attachment of the sliding shutter in a schematic side view on the left, and in a schematic front view on the right. FIG. 5 illustrates the internal structure of the sliding shutter. FIG. 6 is a schematic side view illustrating a mechanism for attaching a side panel and a mechanism for illuminating the side panel. FIG. 7 is a schematic vertical cross-sectional view illustrating the mechanism for attaching a side panel and the mechanism for illuminating the side panel. FIG. 8 is a schematic side view illustrating a mechanism for attaching an exit door and a mechanism for illuminating the exit door. FIG. 9 is a schematic lateral cross-sectional view illustrating the mechanism for attaching the exit door and the mechanism for illuminating the exit door. FIG. 10 shows the arrangement of passage detection sensors. FIG. 11 is a diagram of a control block of the gate apparatus. FIG. 12 is a flow diagram of a control procedure of the gate apparatus. FIG. 13 shows the operation of the gate apparatus when passage is allowed. FIG. 14 shows the operation of the gate apparatus when the passage is not allowed. FIG. 15 shows the operation of the gate apparatus when a wheelchair passes through.

### (General Structure of Gate Apparatus)

In FIGS. 1 and 2, reference character 1 indicates the gate apparatus of the present embodiment. The gate apparatus 1 includes a left body 2 and a right body 3 which are in the shape of a divider, and are arranged parallel to each other with space formed therebetween to form a straight passageway (a gate passageway) extending in a front-back direction. The left body 2 and the right body 3 constitute a left sidewall and a right sidewall of the gate passageway, respectively. The left and right sidewalls comprised of the left and right bodies 2 and 3 are about as high as a chest of an adult, for example. The passageway formed between the left body 2 and the right body 3 is as long as a distance of a few steps of an adult, and is about twice as wide as a shoulder width of an adult, for example.

An entrance arch 4 and an exit arch 5 are provided on an entrance side and an exit side of the gate passageway, respectively. A side panel 6 is formed on an upper surface of the left body 2 to extend between a left column of the entrance arch 4 and a left column of the exit arch 5, and a side panel 6 is formed on an upper surface of the right body 3 between a right column of the entrance arch 4 and a right column of the exit arch 5. The side panels 6 are made of a transparent resin, and are provided to prevent a person from crossing over the gate passageway in the lateral direction.

An exit door 7 is provided on the exit side of the gate passageway. The exit door 7 is a double door, and is supported inside the exit arch 5 in a rotatable manner.

An entrance identification section 8 comprising a first identification section is placed in front of the right column of the entrance arch 4, and a camera 9 as a second identification section is placed in front of the right column of the exit arch 5.

The gate apparatus 1 includes a plurality of sliding shutters which are arranged along the passageway, and slide across the passageway to open/close the passageway as a restriction section which is configured to restrict at least forward and rearward travel of a person traveling from the entrance to the exit of the passageway formed between the left body 2 and the right body 3 in the gate apparatus 1 to form space divided within the passageway, and is capable of adjusting the shape of the defined space based on previously registered shape information of the individual person. Each of the sliding shutters is comprised of a pair of open/close members 10 which extend and contract like a double door. In the example shown in FIG. 1, eight pairs of open/close members 10 are sequentially arranged from the entrance to the exit, and the eight pairs of open/close members 10 constitute eight sliding shutters aligned in the front-back direction.

Passage detection sensors 11, each of which detects the passage of the person, are arranged on an upper portion of a surface of the left body 2 facing the passageway (the gate passageway), and an upper portion of a surface of the right body 3 facing the passageway (the gate passageway) to correspond to the open/close members 10 of the sliding shutters.

The entrance identification section 8 constitutes the first identification section, and includes a camera 12 for palmprint identification (a palmprint sensor), and a camera 13 for face identification which are used to identify whether the person is previously authorized to pass through. With the provision of both the camera 12 for palmprint identification (a palmprint sensor) and the camera 13 for face identification, identification can be performed with higher precision. However, other identification means may be used as long as it can identify the person as a person who is previously authorized to pass through. For example, the first identification section may be one of the camera 12 for palmprint identification and the camera 13 for face identification, other biometric identification section such as a fingerprint identification section, and an identification section which reads a card.

The entrance identification section 8 contains previously registered information about faces and palmprints of individual persons who are previously authorized to pass through. Then, a face of a person standing in front of the entrance identification section 8 is photographed by the camera 13, and the person's palmprint is photographed by the camera 12 to check them against the registered information, thereby determining whether the person is allowed to pass through (when the obtained information matches with the registered information, the person is identified as an authorized person, and is allowed to pass through).

The entrance identification section 8 includes a human detection sensor 14a which detects the person standing in front of the entrance identification section 8, and a light 15 which illuminates the person's face for taking the person's image by the camera 13 for face identification. The entrance identification section 8 further includes a palm table 16 which is about as high as a waist of the person. The camera 12 for palmprint identification is arranged upward at almost the center of a top surface of the palm table 16. The person places the person's palm on the palm table 16 to be photographed by the camera 12. A sensor 14b is provided to detect the person's palm placed on the camera 12. The sensor 14b is arranged on a perpendicular wall where the sensor 14a and the camera 13 are arranged near a junction with the palm table 16. The sensor 14b may be, for example, a distance setting type reflective photosensor, and throws light extending along the top surface of the palm table 16 to cross almost the center of the camera 12. Thus, the sensor 14b reliably detects that the person's palm is placed on the camera 12, thereby satisfactorily controlling timing of operating the camera 12.

The entrance identification section 8 constitutes a shape information registration section which previously registers shape information of individual persons who are previously authorized to pass through. When the person is identified as a person who is authorized to pass through, identification of the shape information is performed. Then, the size of the defined space which allows the person to pass through the gate is adjusted based on the identified shape information.

The camera 9 at the exit is provided to check whether the person who entered the gate apparatus 1 is identical to the person identified by the entrance identification section 8. When the person is not determined as the identical person, the person is recognized as doing impersonation, and is not allowed to pass through. The second identification section is not limited to the camera, but should be a biometric identification section which performs face identification etc., because identification using a card or a pin number may allow passage of other person who borrowed the card, or obtained the pin number.

### (Sliding Shutter and Drive Mechanism Therefor)

Each of the open/close members 10 of the sliding shutters includes, as shown in FIGS. 3 to 5, a base 20, a first attachment 32a, a second attachment 32b, and a third attachment 32c. Shapes of the base 20, the first attachment 32a, the second attachment 32b, and the third attachment 32c are sequentially reduced in this order, and are coupled in a telescopic manner, thereby allowing the open/close member to extend and contract. The base 20 has a leg 21 at the bottom. Each of the sliding shutters 10 includes the bases 20 arranged in the left body 2 and the right body 3 of the gate apparatus 1, respectively. Each of the first attachment 32a, the second attachment 32b, and the third attachment 32c includes casters 33 fixed to upper and lower portions of a front surface, and upper and lower portions of a rear surface, respectively. The base 20 includes slide rails 30 fixed to upper and lower portions of a front surface, respectively, and slide rails 30 fixed to upper and lower portions of a rear surface, respectively. Each of the first attachment 32a and the second attachment 32b includes slide rails 34 fixed to upper and lower portions of the front surface, respectively, and slide rails 34 fixed to upper and lower portions of the rear surface, respectively. When the sliding shutter extends or contracts, the casters 33 on the upper and lower portions of the front and rear surfaces of the first attachment 32a slide on the slide rails 30 on the upper and lower portions of the front and rear surfaces of the base 20, the casters 33 on the upper and lower portions of the front and rear surfaces of the second attachment 32b slide on the slide rails 34 on the upper and lower portions of the front and rear surfaces of the first attachment 32a, and the casters 33 on the upper and lower portions of the front and rear surfaces of the third attachment 32c slide on the slide rails 34 on the upper and lower portions of the front and rear surfaces of the second attachment 32b. A cushion 36 is provided on the third attachment 32c for safety in case of contact with the person.

A drive mechanism for driving the open/close members 10 of the sliding shutters includes a pantograph linkage which includes a pair of straight rod-shaped upper links 26a and 26b and a pair of straight rod-shaped lower links 26c and 26d, and is coupled to a belt 25 arranged inside the base 20, and a motor 22 which drives the linkage to extend and contract.

The motor 22 is arranged at an uppermost portion in the base 20. A drive pulley 23 is fixed to an end of an output shaft of the motor 22, and a driven pulley 24 is arranged at a lowermost portion in the base 20. The belt 25 is looped over the pulleys 23 and 24.

The upper links 26a, 26b intersect with each other at their centers, and are coupled together in a rotatable manner. The lower links 26c, 26d also intersect with each other at their centers, and are coupled together in a rotatable manner.

An end of a first link 26a which is one of the upper links 26a, 26b, and is phase-shifted in the clockwise direction relative to a second link 26b when viewed from one of the front-back directions, and an end of a fourth link 26d which is one of the lower links 26c, 26d, and is phase-shifted in the counterclockwise direction relative to a third link 26c when viewed from the one of the front-back directions, are rotatably supported by an upper portion and a lower portion of the base 20, respectively. The other end of the first link 26a, and the other end of the fourth link 26d are vertically slidable along a link slide rail 35 fixed to the third attachment 32c.

An end of the second link 26b which is phase-shifted in the above-described counterclockwise direction relative to the first link 26a is rotatably coupled to one of parts of the belt 25 parallel to each other between the drive pulley 23 and the driven pulley 24 with a binding member 27, and an end of a third link 26c which is phase-shifted in the above-described clockwise direction relative to the fourth link 26d is rotatably coupled to the other part of the belt 25 between the drive pulley 23 and the driven pulley 24 with a binding member 28. The end of the second link 26b and the end of the third link 26c are vertically slidable in opposite directions in accordance with the movement of the belt 25. The other end of the second link 26b, and the other end of the third link 26c are rotatably supported by an upper portion and a lower portion of the third attachment 32c, respectively.

The sliding shutters (the open/close members 10) can be extended by driving the motor 22 in the clockwise direction, and can be contracted by driving the motor 22 in the counterclockwise direction in the left view of FIG. 3. Thus, the degrees of extension of the sliding shutters (the open/close members 10) can optionally be adjusted by adjusting the rotation angle of the motor 22.

The base 20 includes a microswitch 29 which detects that the sliding shutter (the open/close member 10) is extended to the maximum length from the position of the binding member 27 which couples the second link 26b to the belt 25. A detection signal of the microswitch 29 is used to check the drive state of the sliding shutter 10, or to reset the sliding shutter 10.

### (Side Panel, Exit Door, and Mechanism for Illuminating Them)

In the gate apparatus 1, upper portions of the sidewalls (the side panels 6), and a door (the exit door 7) are made of translucent plates. As shown in FIGS. 6 to 9, light from a light emitting member (light emitting members 42, 47) is applied to an end face of each plate. The light enters the plate which functions as a light guiding plate, is diffused inside the plate, and is emitted from surfaces of the plate. Thus, the upper portions of the sidewalls and the door of the gate apparatus 1 are illuminated to give information to the person, or for the design purpose.

The side panel 6 is a formed product made of a transparent resin, such as acryl etc. As shown in FIGS. 6 and 7, the side panel 6 is fitted in a fitting groove 40 formed in a top surface of the left body 2 (the same goes for the right body 3), and is fixed with a screw 41 in such a manner that a gap is formed between a lower end face of the side panel 6 and a bottom surface of the fitting groove 40. In this case, a light emitting member 42 is arranged in advance in the gap between the lower end face of the side panel 6 and the bottom surface of the fitting groove 40.

The light emitting member 42 is in the shape of a rod including a plurality of light emitting portions, each of which includes a set of LEDs of three different colors. The light emitting member 42 is arranged to face the lower end face of the side panel 6 along the whole length thereof.

The side panel 6 functions as a light guiding plate. Light emitted from the light emitting member 42 enters the side panel 6 from the lower end face, and is diverged outside from the surfaces of the side panel 6.

The exit door 7 is also a formed product made of a transparent resin, such as acryl etc. As shown in FIGS. 8 and 9, two fittings 43, each of which is in the shape of mirrored C when viewed in section, and is slightly taller than the exit door 7, are arranged parallel to each other. One of lateral ends of the exit door 7 is sandwiched between the fittings 43, and is fixed with a screw 45. Further, a base fitting 44 having the same height as the fittings 43 and a flat C-shaped section is fixed to the two fittings 43 back to back. In a direction of the thickness of the door, the base fitting 44 has the same dimension as the sum of the dimensions of the two fittings 43 plus the thickness of the exit door 7 sandwiched therebetween. Thus, the base fitting 44 and the two fittings 43 form a column which is substantially in the shape of H when viewed in section. Rotation shafts 46 are fixed by welding to an upper end and a lower end of the column formed by the two fittings 43 and the base fitting 44, respectively (although FIG. 8 shows only the rotation shaft 46 at the upper end, the rotation shaft 46 is also fixed coaxially to the lower end). The rotation shafts 46 are coupled to a motor 61 described later to drive the exit door 7 to open and close.

A light emitting member 47, which is similar to the light emitting member 42 arranged to apply light to the lower end face of the side panel 6, is bonded to the inside of the base fitting 44 to face the whole end face of the fixed end of the exit door 7. A plurality of holes 48 are formed in a bottom surface of the base fitting 44 to correspond to the arrangement of the LEDs of the light emitting member 47.

The exit door 7 functions as a light guiding plate like the side panel 6. The light emitted from the light emitting member 47 enters the exit door 7 from the end face of the fixed end, and is diverged outside from the surfaces of the exit door 7.

Illumination of the whole part of the side panels 6 and the exit door 7 can be used as a section for providing information to the person. For example, red light is emitted when the person is not identified as a person who is allowed to pass through, thereby informing the person that the person is not allowed to pass through, and green light is emitted when the person is allowed to pass through. Thus, whether the person is allowed to pass through or not can clearly be indicated by the difference in color of the light.

Further, illumination of the whole part of the side panels 6 and the exit door 7 can also be used as a section for improving the design. For example, when the gate is in the standby state and no one passes through the gate, the side panels 6 and the exit door 7 may constantly be illuminated, or may blink with light of the predetermined color, or lights of different colors may be emitted in a switchable manner every predetermined time. Further, since each of the light emitting members 42, 47 includes a plurality of LEDs, the colors of the LEDs may be varied to provide gradations in color.

The light emitting members 42, 47 are not limited to those including the LEDs of three different colors described above, and can suitably be modified in accordance with the intended color of light. For example, only red LEDs are used to emit red light only when the passage is not allowed. Light emitting members except for the LEDs, such as fluorescent lamps, may also be used.

The light emitting member 42 is arranged to face the lower end face of the side panel 6 along the whole length thereof, or the light emitting member 47 is arranged to face the whole end face of the fixed end of the exit door 7. However, the light emitting member may be arranged to face only a portion of the corresponding end face depending on the output of the light emitting member 42, 47 (brightness), an optical guiding rate of the side panels 6 and the exit door 7, etc.

In this embodiment, the side panels 6 and the exit door 7 are illuminated. However, other parts of the gate apparatus 1 which may come within the person's sight may be illuminated. For example, the entrance arch 4, the exit arch 5, upper portions of the left and right bodies 2 and 3, the open/close members 10 of the sliding shutters, etc., may be illuminated in part or in whole.

### (Arrangement of Passage Detection Sensor)

As described above, passage detection sensors 11, each of which detects the passage of the person, are arranged on an upper portion of the wall surface of the left body 2 facing the passageway (the gate passageway), and an upper portion of the wall surface of the right body 3 facing the passageway (the gate passageway) to correspond to seven open/close members 10 of the sliding shutters except for one of the open/close members 10 at the frontmost position. The passage detection sensors 11 are optical transmission sensors in which light is transmitted from one of the left body 2 and the right body 3, and is received by the other. FIG. 10 shows the arrangement of the passage detection sensors 11.

In this embodiment, eight pairs of open/close members 10 of the sliding shutters are provided, and seven passage detection sensors 11 are arranged to correspond to the open/close members of the sliding shutters except for the sliding shutter at the frontmost position. In FIG. 10, first to eighth sliding shutters aligned from the entrance to the exit of the gate passageway, each of which is comprised of a pair of open/close members 10, are indicated by reference characters 10a to 10h, respectively, and first to seven passage detection sensors 11 aligned from the entrance to the exit of the gate passageway are indicated by reference characters 11a to 11g, respectively. The passage detection sensors 11a to 11g detect that the person has passed the corresponding sliding shutters 10a to 10g.

As shown in FIG. 10, in the gate apparatus 1, a passage detection sensor 50 for detecting passage of a wheelchair (hereinafter may be referred to as a wheelchair sensor) is arranged on each of the wall surface of the left body 2 and the wall surface of the right body 3 facing the passageway (the gate passageway) to be positioned slightly below the vertical center of the passageway. Further, on the same wall surface of the left body 2 and the same wall surface of the right body 3, a passage detection sensor 51 for detecting the person passing through the exit door 7 (hereinafter referred to as an exit sensor) is arranged near the exit of the passageway at substantially the same level of the wheelchair sensor 50. The wheelchair sensor 50 and the exit sensor 51 are also optical transmission sensors in which light is transmitted from one of the left body 2 and the right body 3, and is received by the other. The wheelchair sensor 50 detects that a person using a wheelchair has proceeded to almost the center of the gate apparatus 1. The exit sensor 51 detects a person who has passed the sliding shutter 10h which is the closest to the exit, and is about to pass through the exit door 7.

### (Structure of Control System)

FIG. 11 shows the structure of a control system of the gate apparatus of the present embodiment. The gate apparatus includes a control section 60. To the control section 60, the passage detection sensors 11, 50 and 51, the microswitch 29, drive sensors 62, an emergency stop switch 63 are input connected, a face identification unit 64 and a palmprint identification unit 65 are input and output connected, and the light emitting members 42, 47, sixteen motors 22 for driving the sliding shutters to extend and contract, and a single motor 61 for driving the exit door 7 to open/close are output connected. The control section 60 is connected to a power source box 66.

The drive sensors 62 detect the drive states of the motors 22 and 61. The emergency stop switch 63 is arranged on a lower portion of the left body 2 or the right body 3, and is generally handled by an attendant to stop the operation of the gate apparatus 1 in case of an emergency.

The face identification unit 64 is connected to the entrance identification section 8 including the camera 13 for face identification and a light 15 for illumination, thereby constituting a first identification section which identifies whether the person is identical to a previously registered person by checking the image data obtained by the camera 13 against the registered information (stored face data). Further, the face identification unit 64 is also connected to the camera 9 at the exit, thereby constituting a second identification section which identifies whether the person is identical to the previously registered person by checking the image data obtained by the camera 9 at the exit, and identifies whether the person is identical to the person identified by the first identification section.

The palmprint identification unit 65 is connected to the camera 12 for palmprint identification (a palmprint sensor), and checks the image data obtained by the camera 12 against the registered information (stored palmprint data).

### (Control Procedure and Operation)

The gate apparatus 1 performs identification of the person by the first identification section including the face identification unit 64 which performs face identification using the camera 13 of the entrance identification section 8, and the palmprint identification unit 65, and obtains shape information of the person by the shape information obtaining section, thereby opening/closing the open/close members 10 of the sliding shutters to allow the person to pass through. Space surrounding the person is defined by opening some of the open/close members 10 of the sliding shutters, and the defined space is moved in accordance with the travel of the person by sequentially opening/closing the open/close members 10 of the sliding shutters. In this case, the size of the defined space is suitably adjusted based on the person's shape information to prevent tailgating. While the person is traveling the gate apparatus 1, identification by the second identification section, which is the camera 9 at the exit, is performed to check whether the traveling person is identical to the person identified by the first identification section, thereby preventing impersonation.

Referring to FIGS. 13 and 14, an example of the control procedure will be described in detail along a flowchart of FIG. 12.

The gate apparatus 1 is kept in a standby state P131 in FIG. 13 until the human detection sensor 14a detects a person standing in front of the entrance identification section 8 in step S1 of the control procedure shown in FIG. 12, and the sensor 14b detects a palm of the person placed on the camera 12.

In step S1, when the human detection sensor 14a of the entrance identification section 8 detects the person approaching, and the sensor 14b detects the person's palm being placed above the camera, data of the person's palmprint and face is obtained by the entrance identification section 8 in step S2. The obtained data is checked against the previously registered data for identification (to identify whether the person is a registered person or not). The entrance identification section 8 is used also as a shape information obtaining section. When the identification has succeeded, the information that the identification has succeeded, and the shape information previously stored in correspondence with the information for identification of the person are sent to the control section 60.

Upon receiving the information that the identification has succeeded, the control section 60 allows the light emitting members 42, 47 to emit green light to turn the side panels 6 and the exit door 7 green, thereby informing the person that the person can pass through in step S3.

In step S4, the motor 22 for driving the first and second sliding shutters 10a and 10b is driven to open the first and second sliding shutters 10a and 10b, i.e., to bring these shutters into the state P132 shown in FIG. 13. In this state, the degrees of opening of the first and second sliding shutters 10a and 10b (the degree of opening of the shutter) are adjusted based on the person's shape information. For example, three types of lateral width of the person are registered in advance as the shape information based on the width of the person's shoulder or waist, and a determination is made which one of the three types the obtained shape information is, thereby setting the necessary and sufficient degree of opening of the shutter in accordance with the lateral width.

In step S5, a determination is made whether the first passage detection sensor 11a is turned from on to off to check whether the person has passed the first sliding shutter 10a. When the person enters the gate apparatus 1, the first passage detection sensor 11a arranged between the first sliding shutter 10a and the second sliding shutter 10b to correspond to the first sliding shutter 10a is turned on. As the person travels forward, the first passage detection sensor 11a is turned off. The control section 60 determines that the person has passed the first sliding shutter 10a when the first passage detection sensor 11a is turned from on to off

When a determination is made that the person has passed the first sliding shutter 10a, operation of opening the third sliding shutter 10c, and closing the first sliding shutter 10a is started in step S6. In this step, as shown in the state P133 in FIG. 13, the first to third sliding shutters 10a to 10c form space only for a single person (defined space), thereby preventing tailgating by another person who attempts to follow the person identified at the entrance. When two persons attempt to enter the defined space, the first sliding shutter 10a cannot be normally closed. Therefore, the illegal entry can be detected.

In step S7, a determination is made whether the second passage detection sensor 11b is turned from on to off to determine whether the person has passed the second sliding shutter 10b. When a determination is made that the person has passed the second sliding shutter 10b, operation of opening the fourth sliding shutter 10d, and closing the second sliding shutter 10b is started in step S8. In this step, as shown in the state P134 in FIG. 13, the second to fourth sliding shutters 10b to 10d keep the space only for a single person (the defined space).

In step S9, a determination is made whether the third passage detection sensor 11c is turned from on to off to determine whether the person has passed the third sliding shutter 10c. When a determination is made that the person has passed the third sliding shutter 10c, operation of closing the third sliding shutter 10c is started in step S10. At this time, the fifth sliding shutter 10e is not opened yet, and the gate remains in the state P135 in FIG. 13.

Then, in step S11, identification is performed by the face identification unit 64 as the second identification section (identification using the camera 9 at the exit), and the result is reflected on the subsequent gate control.

The identification by the second identification section (the identification using the camera 9 at the exit) is performed after the person has entered the gate apparatus 1. Face information obtained by the camera 9 is checked against the previously registered information used for the identification by the first identification section (the identification using the camera 13 of the entrance identification section 8), and the check result is sent to the control section 60.

The control section 60 compares the check result of the face identification by the second identification section, and the check result of the first identification section. When both pieces of the face information are determined to be identical to the person who has previously been registered (the second identification has succeeded), the person is allowed to pass through, and operations of steps S12 and S13 are performed. On the other hand, when the face information from the second identification section and the face information from the first identification section are not determined to be identical to the person who has previously been registered (the second identification has failed), the person is not allowed to pass through, and operations of steps S14 to S19 are performed. This can prevent a third person from entering and passing through the gate apparatus 1 immediately after the identification of the previously registered person by the first identification section, i.e., illegal entry by “impersonation.”

When a determination is made that the second identification has succeeded in step S11, the control section 60 opens the fifth to eighth sliding shutters 10e to 10h near the exit in step S12 to bring the shutters into the state P136 shown in FIG. 13, thereby allowing the person to pass the fifth to eighth sliding shutters 10e to 10h, and to exit from the exit door 7 which is kept open from the beginning.

In step S13, the fourth to eighth sliding shutters 10e to 10h are sequentially closed in accordance with the travel of the person, i.e., in accordance with the timings at which the fourth to seventh passage detection sensors 11d to 11g and the exit sensor 51 are sequentially turned from on to off.

When a determination is made that the second identification has failed in step S11, i.e., a determination is made that the person who has passed the third sliding shutter 10c is not allowed to travel forward anymore, the color of the light emitted by the light emitting members 42, 47 is changed from green to red in step S14 to inform the person that the person cannot pass through. In this step, the sliding shutters 10a to 10h are in the state P141 shown in FIG. 14.

In step S15, the control section 60 drives the motor 61 to close the exit door 7 in case that the person may forcibly step over the fifth to eighth sliding shutters 10e to 10h. In step S16, the first to third sliding shutters 10a to 10c behind the person are all opened as in the state P142 shown in FIG. 14, thereby allowing the person to return to the entrance. In step S17, as the person returns to the entrance, i.e., in accordance with timings at which the first to third passage detection sensors 11a to 11c are sequentially turned from on to off, the second to fourth sliding shutters 10b to 10d are sequentially closed from the exit side.

In step S18, the first sliding shutter 10a is closed after a lapse of the predetermined time from the closing of the second sliding shutter 10b, and the exit door 7 is opened in step S19. Thus, the gate is returned to the standby state P131 shown in FIG. 13.

After the person has traveled normally through steps S12 and S13, or after the person who is not allowed to travel is returned to the entrance, and the sliding shutters 10a to 10h and the exit door 7 are reset to the standby state through steps S14 to S19, the output of the light emitting members 42, 47 is stopped, or the color of the light is switched to the standby color in step S20.

In the case where the second identification section is configured to identify the person by an ID card, or a pin number, intentional “impersonation” by a person who borrowed the card, or obtained the pin number may be possible. Therefore, the best identification by the second identification section is biometric identification free from these possibilities. In this embodiment, the camera 9 is used as the second identification section to perform the face identification. Thus, the number of persons in the gate apparatus 1 can be checked. Accordingly, when two or more persons are found in the gate apparatus 1, their passage is not allowed (the second identification has failed). This can prevent the tailgating with more reliability.

In this gate apparatus 1, the first to fourth sliding shutters 10a to 10d are sequentially opened in accordance with the travel of the person as shown in the states P131 to P135 in FIG. 13 in a period from when the person has passed the first sliding shutter 10a to when the person has passed the third sliding shutter 10c, thereby sequentially moving the defined space in the traveling direction. Thus, the person can pass through the gate without stopping. The face identification unit 64 as the second identification section performs face identification using the camera 9 at the exit, and the identification is started immediately after the person has passed the first sliding shutter 10a to take an image of the traveling person by the camera 9 at a distance from the person. Thus, the person does not have to stop for the identification, thereby allowing the second identification in the gate apparatus 1 without interrupting the travel of the person.

### (Person Using Wheelchair)

For a person using a wheelchair, the shape information is previously registered to include information about the shape of the wheelchair. In the standby state P151 shown in FIG. 15, when the human detection sensor 14 detects the person standing in front of the entrance identification section 8, and the person is recognized as a person using a wheelchair by the image taken by the camera 13, the sliding shutters (the first to eighth sliding shutters 10a to 10h) are controlled to form space defined in the gate apparatus 1 based on the shape information of the person including the wheelchair.

For example, in the state P152 shown in FIG. 15, the first to sixth sliding shutters 10a to 10f are opened first. Then, after the wheelchair sensor 50 detects that the wheelchair has proceeded just in front of the sixth sliding shutter 10f, and the second passage detection sensor 11b detects that a back of the wheelchair has passed the second sliding shutter 10b, the first and second sliding shutters 10a and 10b are closed to bring the sliding shutters in the state P153 shown in FIG. 15.

In this manner, the defined space only for the person using the wheelchair is formed in the gate apparatus 1. In this case, which sliding shutters should be opened is determined based on the size of the wheelchair included in the shape information. If the size of the wheelchair is substantially uniform, the sliding shutters of the predetermined number may be opened.

In the state P153 shown in FIG. 15, the second identification is performed. When the second identification has succeeded, the seventh and eighth sliding shutters 10g and 10h are opened to guide the person using the wheelchair to the exit. When the second identification has failed, the first and second sliding shutters 10a and 10b are opened to guide the person to the entrance.

### (Alternative Examples of Operation)

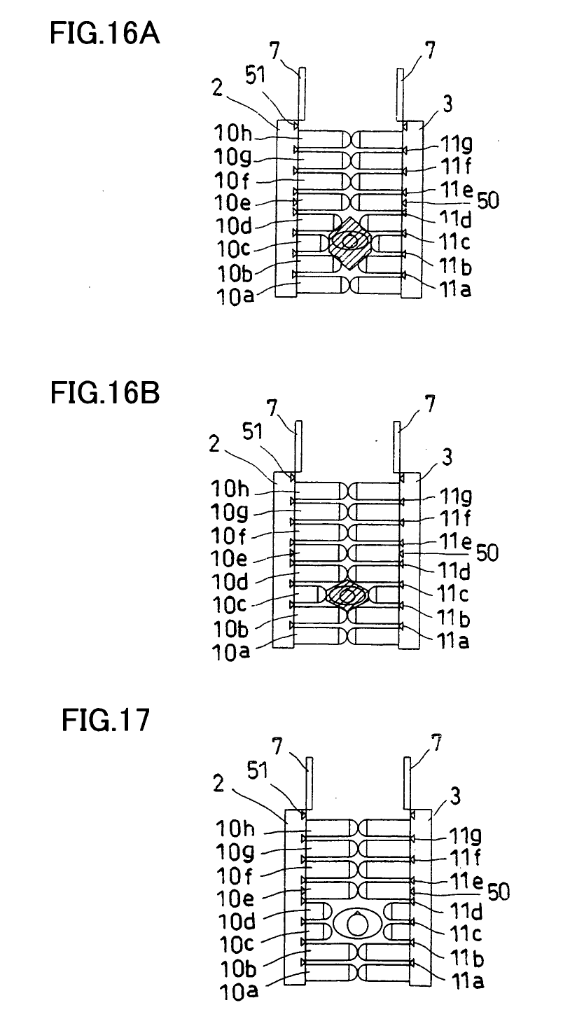

FIG. 16 shows a first alternative example of the operation of the gate apparatus of the first embodiment in a comparative view (FIG. 16A) and a view illustrating the operation (FIG. 16B).

In the first embodiment described above, the sliding shutter forward of the traveling person (the fourth sliding shutter 10d in FIG. 16A) starts to open slightly earlier, and the sliding shutter which the person has passed (the second sliding shutter 10b in FIG. 16A) is closed slightly later for smooth travel of the person. Thus, the defined space is in the shape of a diagonally shaded area shown in FIG. 16A, thereby providing free space around the person. In contrast, in this first operation example, as shown in FIG. 16B, the sliding shutter forward of the traveling person (the fourth sliding shutter 10d in FIG. 16B) is opened after the sliding shutter which the person has passed (the second sliding shutter 10b in FIG. 16B) is completely closed. This allows formation of the smallest defined space as shown in FIG. 16B. In this case, the travel of the person becomes less smooth, but the tailgating can be prevented with more reliability.

FIG. 17 is a view for illustrating the operation of the gate apparatus of the first embodiment according to a second operation example.

In the first embodiment described above, the size of the defined space is adjusted in the lateral direction by adjusting the degrees of opening of the sliding shutters based on the information of the lateral shape of the person, such as the person's shoulder width. However, the size of the defined space is not adjusted based on the size of the person in the front-back direction. In the second operation example, the number of sliding shutters which open simultaneously is also controlled to adjust the size of the space based on the size of the person in the front-back direction.

For example, as shown in FIG. 17, depending on the size of the person in the front-back direction, two adjacent sliding shutters (the third and fourth sliding shutters 10c and 10d in FIG. 17) are simultaneously opened to form the defined space enlarged in the front-back direction. In this way, the sliding shutter may be opened simultaneously with one, two or three sliding shutters to adjust the defined space depending on the size of the person.

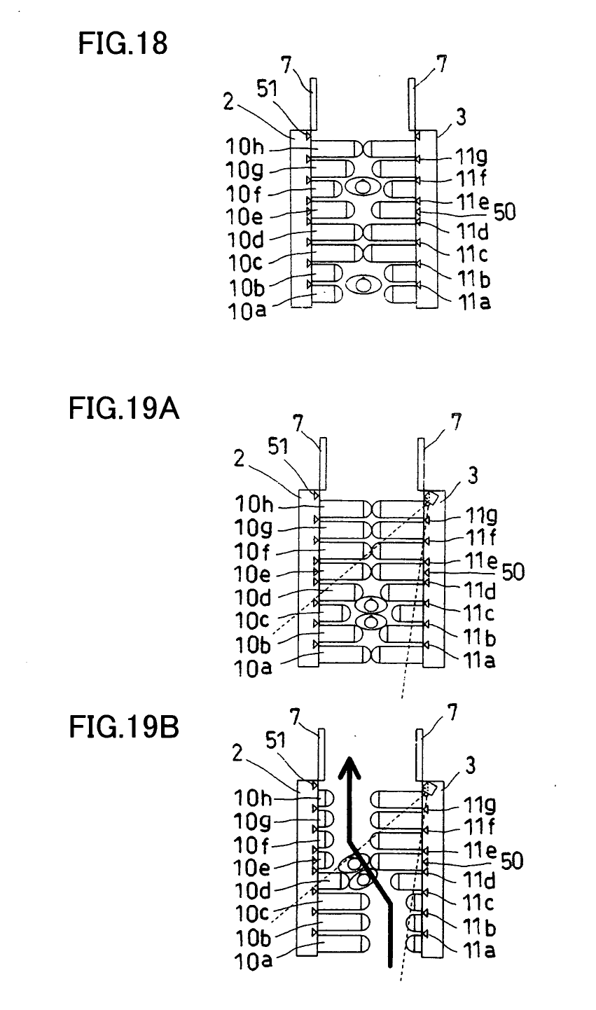

FIG. 18 is a view illustrating the operation of the gate apparatus of the first embodiment according to a third operation example.

In the first embodiment described above, the first and second sliding shutters 10a and 10b are already closed when the person proceeds to almost the center of the gate apparatus 1. When the second identification has succeeded in this state, the fifth to eighth sliding shutters 10e to 10h near the exit are all opened to allow the person to travel to the exit, and then the sliding shutters are returned to the standby state. Thus, the next person cannot enter the gate until all the sliding shutters are returned to the standby state. In contrast, in the third operation example, when the person proceeds to almost the center of the gate apparatus 1, and the first and second sliding shutters 10a and 10b are already closed, the next person is allowed to enter.

Specifically, the entrance identification section 8 is configured to be able to perform the identification continuously, and allows a first person to enter. When the first person is allowed to pass through by the second identification, the entrance identification section 8 is ready for the identification of a second person. When the identification of the second person at the entrance is finished, the first and second sliding shutters 10a and 10b are opened to allow the second person to proceed as shown in FIG. 18. In this way, the person would not have to wait for a long time, thereby allowing smooth travel of the person. Since the second person is allowed to proceed only after the second identification of the first person, the first person who is not identified by the second identification and is returned to the entrance would not interrupt the travel of the second person.

FIG. 19 shows a fourth operation example of the gate apparatus of the first embodiment in a comparative view (FIG. 19A) and a view illustrating the operation (FIG. 19B).

In the first embodiment described above, the sliding shutters are opened/closed symmetrically in the lateral direction, and the defined space moves straight through the center of the gate apparatus 1. Specifically, the movement path of the defined space is parallel to the left body 2 and the right body 3 forming the sidewalls of the passageway, and extends straight through almost the center between the left body 2 and the right body 3.

In the first embodiment described above, the defined space has the size which allows travel of only a single person who is identified by the first identification. However, as shown in FIG. 19A, two persons who are close to each other may forcibly enter the space. In such a case, irregular closing of the sliding shutter, or abnormal load applied to the closing sliding shutter is detected, thereby detecting illegal entry by tailgating. In case of failure in detection, the image taken by the exit camera 9 as the second identification section in the gate apparatus 1 can be processed to detect the simultaneous entry of the two persons. However, when the movement path of the defined space is parallel to the left and right bodies 2 and 3 as described in the first embodiment, the camera 9 may fail to recognize the two persons individually when they are close to each other, and one of them may be hidden behind the other from the camera 9.

In contrast, in the fourth operation example, each of the sliding shutters can open asymmetrically in the lateral direction, thereby inclining the movement path of the defined space relative to the left body 2 and the right body 3, i.e., relative to the sidewalls of the passageway, or forming the movement path of the defined space closer to one of the left body 2 and the right body 3. In this case, individual images of the two persons can be taken, for example, by inclining part of the movement path of the defined space relative to the left body 2 and the right body 3 as shown in FIG. 19B. In FIG. 19B, the passageway opened from the entrance to the exit is formed for the sake of illustration. However, actually, the closed defined space travels from the entrance to the exit to form a curved movement path. In this example, the movement path is slightly rightward, and is parallel to the left and right bodies 2 and 3 between the first to third sliding shutters 10a to 10c. In this section, an image of the person's face can be taken substantially from the front. Between the fourth sliding shutter 10d and the fifth sliding shutter 10e, the movement path is inclined from right to left in the traveling direction relative to the left body 2 and the right body 3. In this section, the persons show their profiles to the camera 9. Thus, the camera 9 can reliably take the images of the two persons who are close to each other in the front-back direction.

### (Alternative Examples)

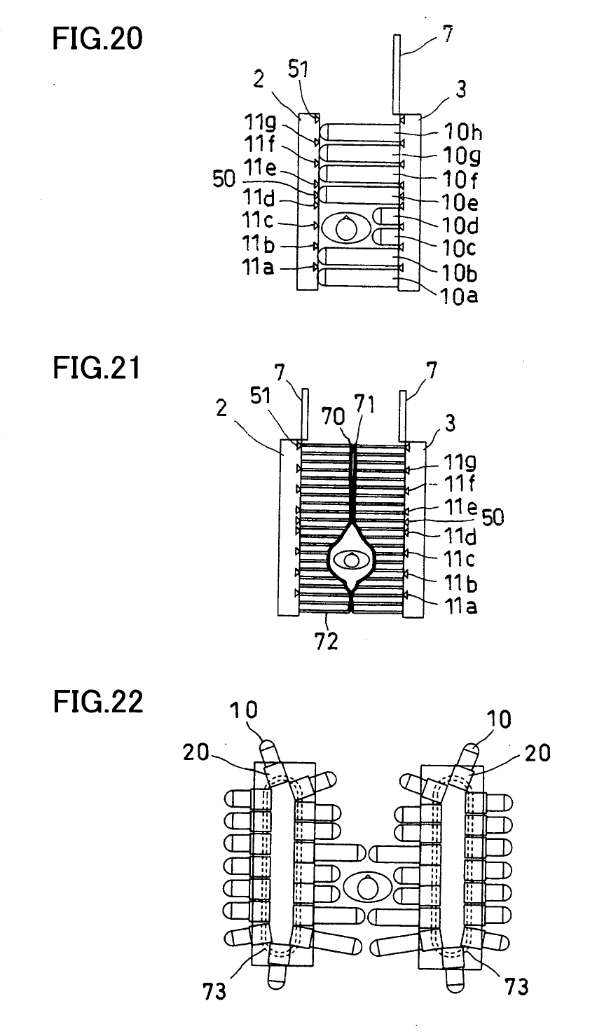

FIG. 20 illustrates the structure and operation of an alternative example of the gate apparatus of the first embodiment.

The gate apparatus of the first embodiment employs the double door sliding shutters. In this alternative example, as shown in FIG. 20, the gate apparatus may employ one-way sliding shutters which extend from and contract to the right body 3. Also in this case, the advantages offered by the first embodiment can be obtained.

FIG. 21 illustrates the structure and operation of another alternative example of the gate apparatus. The gate apparatus of the first embodiment includes the sliding shutters comprised of the open/close members 10 as the restriction section. In this alternative example, a plurality of extendable members 72 protruding from the left body 2 and the right body 3 to the passageway are aligned in the traveling direction and the vertical direction of the passageway as the restriction section. Sheets 70 and 71, each of which is made of stretching cloth etc., are stretched on ends of the extendable members 72 protruding from the left body 2, and on ends of the extendable members 72 protruding from the right body 3, respectively. The pair of sheets 70, 71 form left and right sidewalls of the passageway (the gate passageway).

The extendable members 72 may have the same structure as the open/close members 10 of the sliding shutters of the first embodiment, or may be known extendable members.

In this case, the degrees of extension of the extendable members 72 are individually adjusted to form protruded and recessed wall surfaces by the left and right sheets 70, 71, thereby forming the defined space as shown in FIG. 21.

In this alternative example, the extendable members 72 are sequentially extended and contracted to move the defined space toward the exit. In this alternative example, the right and left sidewalls of the passageway look like smooth flowing walls when the defined space is moved. This can advantageously guide the person to the exit.

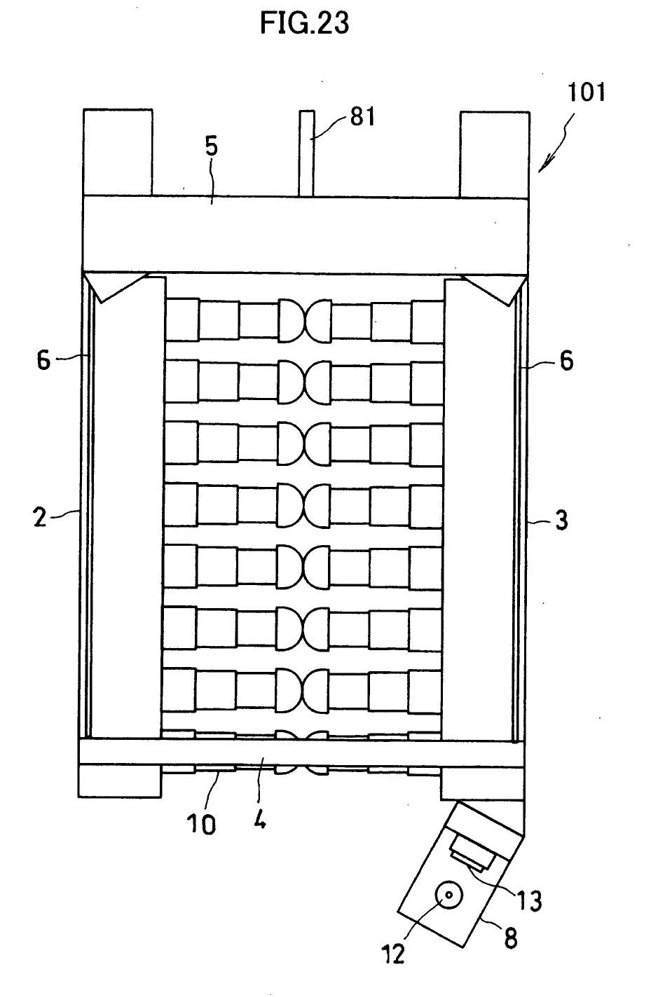

FIG. 22 illustrates the structure and operation of the gate apparatus according to still another alternative example. In this alternative example, rails 73 are formed around the left body 2 and the right body 3, respectively, in such a manner that the bases 20 of the open/close members 10 of the sliding shutters can orbit around the left body 2 and the right body 3 on the corresponding rails 73. In this case, the sliding shutters 10 forming the defined space are moved to the exit along the rail 73 while keeping the defined space. Thus, there is no need to sequentially open and close the sliding shutters to move the defined space.

In the first embodiment, extra space may be formed in opening and closing the sliding shutters to smoothly move the defined space. In this alternative example, the defined space once formed can be moved in the traveling direction. This effectively allows isolation of only the single person.

In this alternative example, the open/close members 10 of the sliding shutters are preferably contracted when they travel from the exit side to the entrance side. This can save footprint of the gate apparatus.

The rail 73 may be formed to orbit on the vertical plane facing the passageway. In this case, the open/close members 10 of the sliding shutters are contracted to the left body 2 and the right body 3 when they return from the exit side to the entrance side. Thus, the sliding shutters do not interrupt the travel of the person, and the volume of the apparatus can further be reduced.

The disclosed technology can be modified in various ways. For example, the shape information obtaining section includes the entrance identification section 8 as the first identification section, and the entrance identification section 8 is arranged outside the gate apparatus 1 near the entrance. However, the shape information obtaining section may be arranged anywhere as long as it can identify the person before the person is enclosed in the defined space. For example, an identification section which identifies the person at a distance from the person using a camera may be arranged inside the gate apparatus 1 near the entrance. Alternatively, when the camera 9 of the second identification section at the exit is capable of recognizing the person near the entrance, only the camera 9 at the exit may be used as the shape information obtaining section.

The shape information is previously stored in correspondence with information about identification of the person. However, when the first identification section is a camera, an image of the person is taken, and is processed to obtain the person's shape information every time the person comes to the gate. Further, a known sensor except for the camera may be arranged to obtain the shape information. In this way, not only the shape information about the body size of the person, but also the shape information including the person's belongings, e.g., bags, trunks, etc., can be obtained, thereby forming the defined space more precisely.

When the camera is used as the first identification section, and a plurality of persons are present in a viewing range of the camera, an image of only the person to be identified has to be clipped. When such image clipping is difficult, a booth in which only a single person can enter may be provided in front of the camera, or a section which informs that two or more persons who are close to each other should not be identified at one time may be provided, thereby obtaining the person's shape information easily. The same goes for the case where a known sensor except for the camera is used as the first identification section.

### SECOND EMBODIMENT

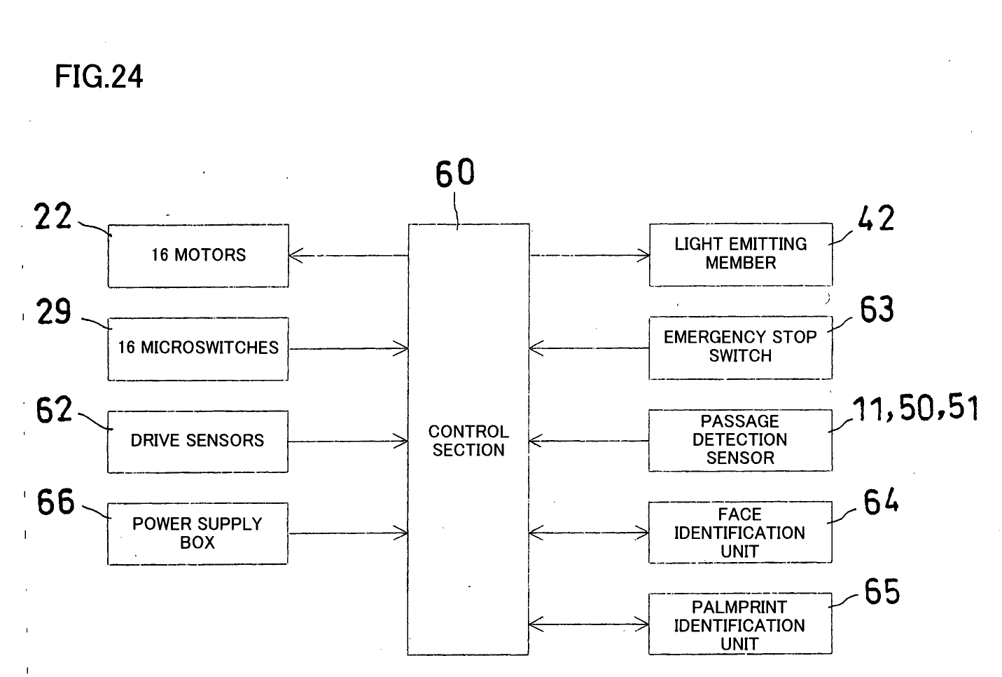

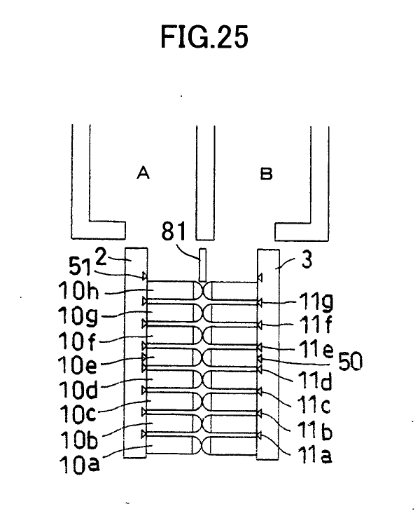

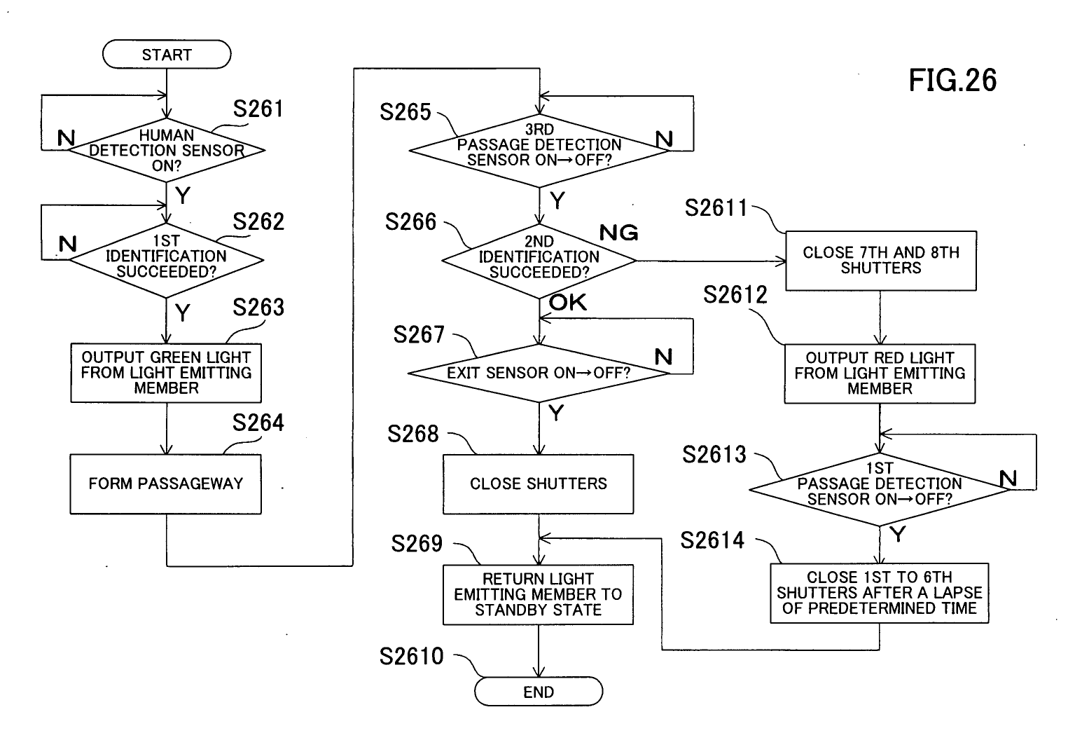

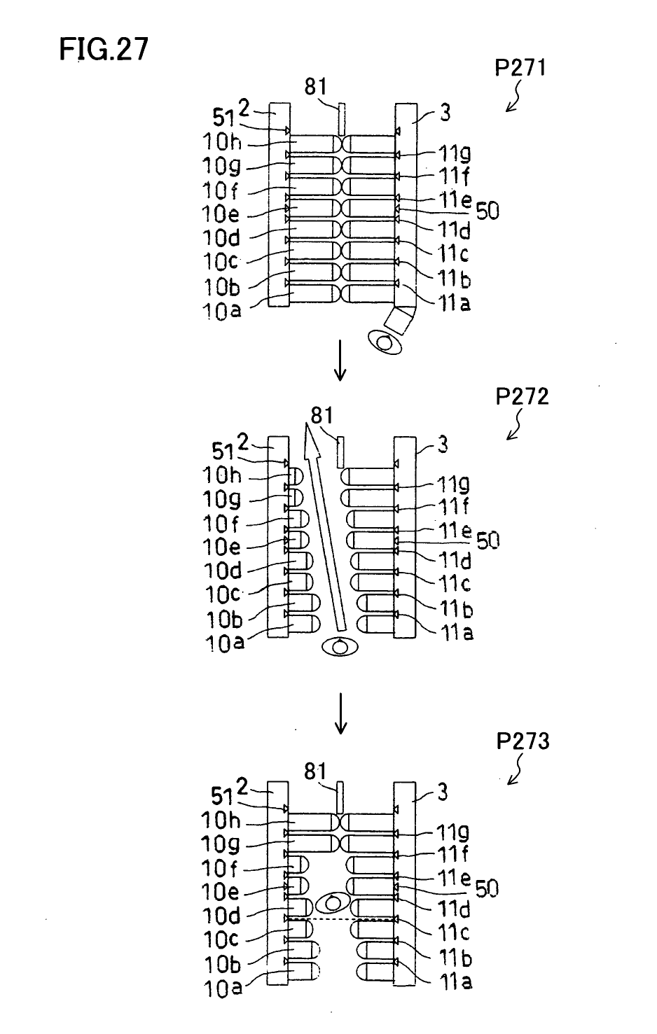

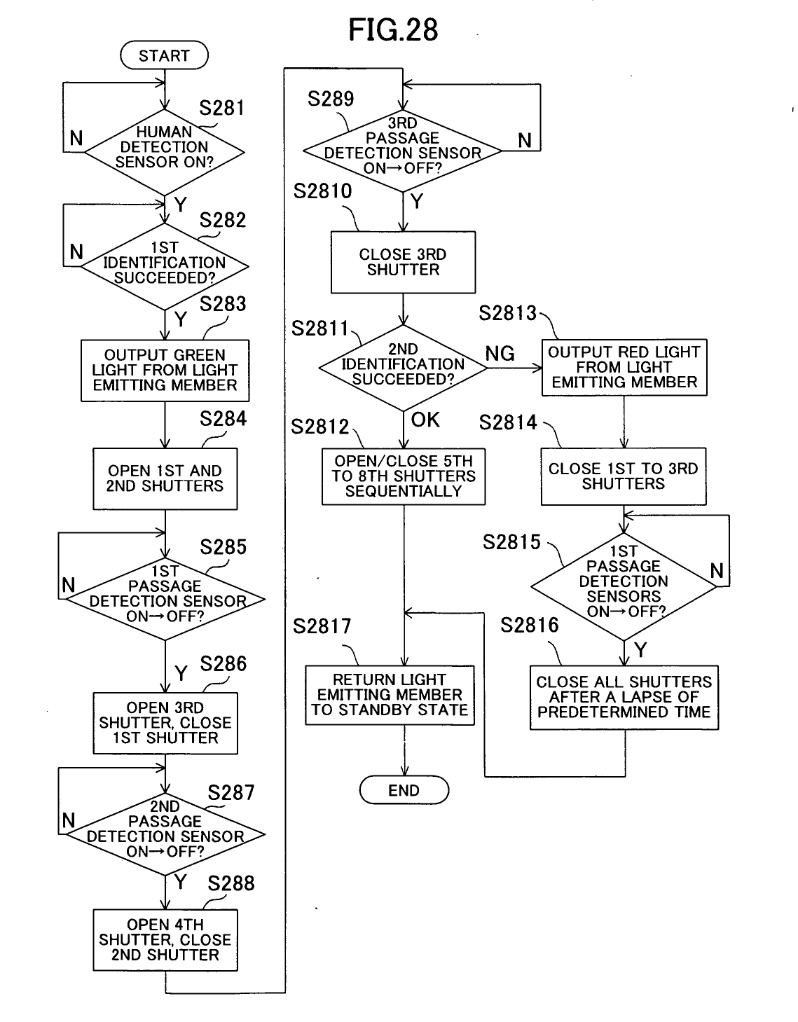

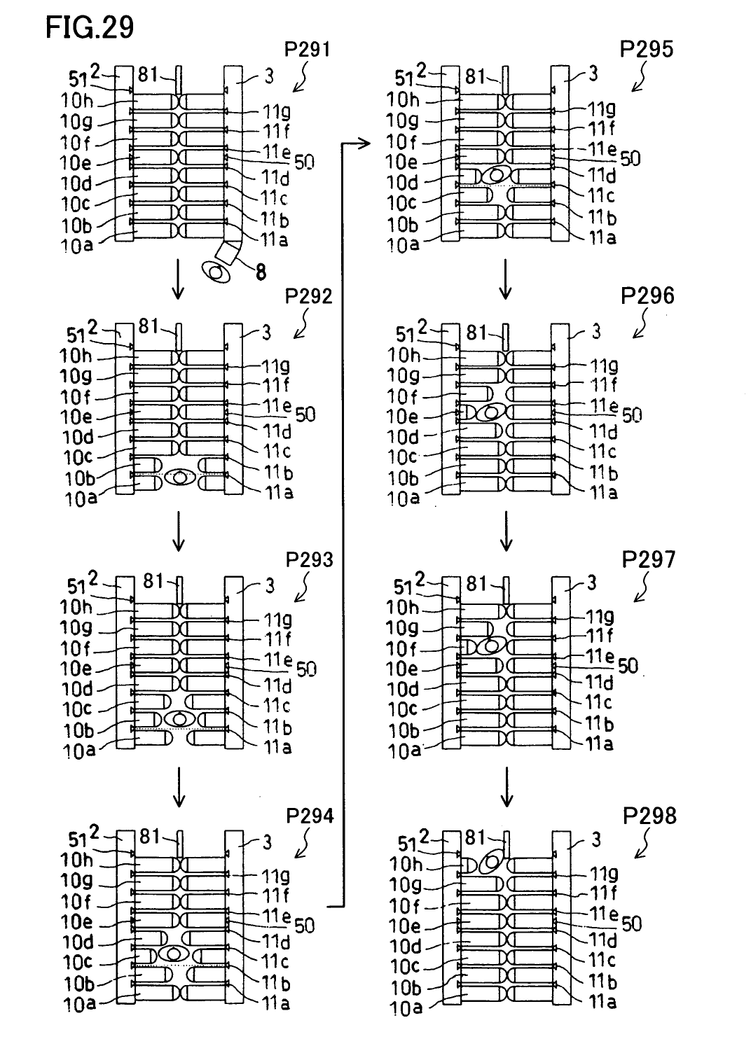

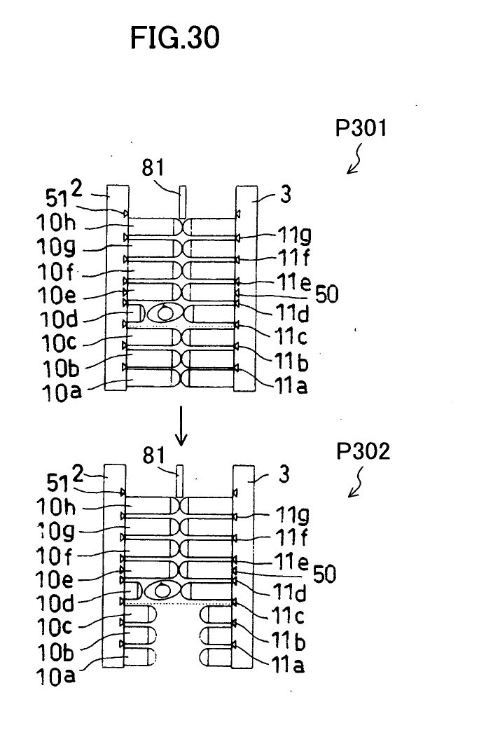

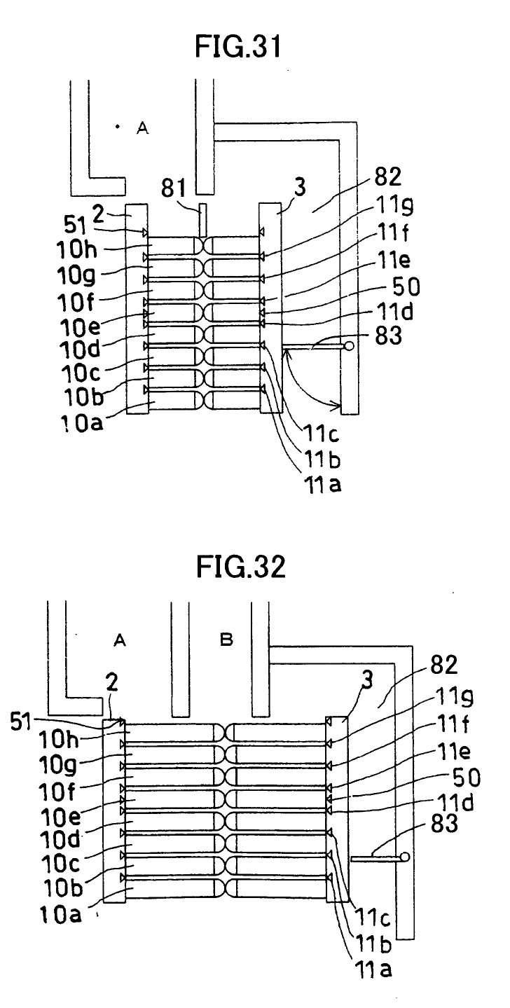

FIGS. 23 to 32 show a second embodiment. FIG. 23 is a plan view of a gate apparatus. FIG. 24 is a diagram of a control block of the gate apparatus. FIG. 25 shows a first installation example of the gate apparatus. FIG. 26 shows a control procedure according to the first operation example of the gate apparatus installed according to a first installation example. FIG. 27 shows the operation according to the first operation example of the gate apparatus installed according to the first installation example. FIG. 28 shows a flow diagram illustrating a control procedure according to a second operation example of the gate apparatus installed according to the first installation example. FIG. 29 shows the operation according to the second operation example of the gate apparatus installed according to the first installation example, in which passage is allowed. FIG. 30 shows the operation according to the second operation example of the gate apparatus installed according to the first installation example, in which the passage is not allowed. FIG. 31 shows a second installation example of the gate apparatus. FIG. 32 shows a third installation example of the gate apparatus.

A gate apparatus 101 of the second embodiment identifies whether the person is authorized to pass through, and additionally, guides the person to one of a plurality of exits. In the gate apparatus 101, components similar to those of the gate apparatus 1 of the first embodiment will be indicated by the same reference characters, and may not be described in detail.

As shown in FIG. 23, in the gate apparatus 101 of the second embodiment, the exit door 7 at the exit of the gate passageway is replaced with an exit divider 81. As described later, the gate apparatus 101 drives and controls the opening/closing of the sliding shutters 10 based on the result of identification of the person, and guides the person (a passenger) to the right or the left of the exit divider 81. The exit divider 81 divides the exit of the gate apparatus 101 to a right exit and a left exit.

FIG. 24 shows a control system of the gate apparatus of the present embodiment. As compared with the control system shown in FIG. 11, the motor 61 for driving the exit door 7 is not provided, and the light emitting member 47 arranged in the exit door 7 is not provided.

### (First Installation Example of Gate Apparatus)

FIG. 25 shows an example of installation of the gate apparatus (a first installation example). In this installation example, a left exit, which is a left part (a part) of the exit of the gate apparatus 101 on the left of the exit divider 81, is connected to an exit passageway A, and a right exit, which is a right part (a part) of the exit of the gate apparatus 101 on the right of the exit divider 81, is connected to an exit passageway B. Such installation of the gate apparatus 101 is advantageous to change the guiding direction of individual persons. For example, the gate apparatus 101 is installed at an entrance of a building in which two different offices are present, and which office the person belongs to, appointments of visitors, etc., are previously registered. Thus, the person can be guided to one of the offices to which the person's access is allowed.

In this case, the gate apparatus 101 stores information for identifying the person (face information, palmprint information, fingerprint information, etc.), and exit information for guiding the person in correspondence with each other. Then, the person is identified by face identification by the camera 13 of the entrance identification section 8, and palmprint identification by the camera 12, both cameras constituting the first identification section, to identify the person, thereby determining the part of the exit to which the person should be guided (the right or left exit). The opening/closing of the sliding shutters (the open/close members 10) is controlled to guide the person to the predetermined part of the exit. While the person is traveling the gate apparatus 101, identification is performed by the second identification section (face identification using the camera 9) to check whether the traveling person is identical to the person identified by the first identification section (the entrance identification section 8). Thus, the impersonation is prevented.

Referring to FIGS. 25 and 27, the control procedure and operation of the gate apparatus 101 according to this installation example (the first operation example) will be described along a flowchart of FIG. 26.

In this operation example (the first operation example), the sliding shutters (the open/close members 10) restrict lateral movement of the person relative to the person's traveling direction in the gate apparatus 101 to form a passageway (a specified passageway) extending from the entrance to a part of the exit, while adjusting the shape of the passageway to connect the passageway to a predetermined part of the exit. Thus, the person's traveling direction in the gate apparatus 101 can be controlled, thereby naturally guiding the person to the predetermined part of the exit without interrupting the smooth travel of the person.

In this example, the gate apparatus 101 is kept in the standby state P271 shown in FIG. 27 until the human detection sensor 14 detects the person standing in front of the entrance identification section 8 in step S261 of the control procedure shown in FIG. 26.

When the human detection sensor 14 of the entrance identification section 8 detects the person approaching in step S261, the entrance identification section 8 obtains data of the person's palmprint and face in step S262, and checks the obtained data against the previously registered data for identification (to identify whether the person is a registered person). When the identification has succeeded, the person is identified, and the part of the exit (the right or left exit) is determined based on the exit information previously stored in correspondence with the information for identifying the person (to which of the right and left exits divided by the exit divider 81 the person should be guided, i.e., whether the person is guided to the exit passageway A or the exit passageway B). The information of the determination is sent to the control section 60 together with the information that the identification has succeeded. The first identification fails when the obtained data does not match with the previously registered data, and the person is not allowed to pass through.

Upon receiving the information that the identification has succeeded, the control section 60 allows the light emitting member 42 to emit green light to turn the side panels 6 green, thereby informing the person that the person can pass through in step S263.

In step S264, the motor 22 for driving the first to eighth sliding shutters 10a to 10h is driven to open the first to eighth sliding shutters 10a to 10h, e.g., to bring the shutters into the state P272 shown in FIG. 27, thereby forming a passageway that leads to the part of the exit which the person should be guided to.

In the state P272 shown in FIG. 27, the sliding shutters 10a to 10h form openings which are gradually shifted to the left from the entrance to the exit, thereby forming a passageway leading the person to the exit passageway A. Thus, the passageway which naturally guides the person from the entrance to the left of the exit divider 81 is formed. The person's shape information may be registered in correspondence with the information for identifying the person, thereby adjusting the degrees of opening of the sliding shutters 10a to 10h based on the person's shape information.

In step S265, a determination is made whether the person has passed the third sliding shutter 10c based on whether the third passage detection sensor 11c is turned from on to off. When it is determined that the person has passed the third sliding shutter 10c, identification (face identification) is performed by the face identification unit 64 and the camera at the exit 9 as the second identification section in step S266, and the result is reflected on the subsequent gate control.

The identification by the second identification section (face identification using the camera 9 at the exit) is performed on the person who has entered the gate apparatus 1. The face information obtained by the camera 9 is checked against the previously registered information which is used for the identification by the first identification section (the face identification using the camera 13 of the entrance identification section 8), and the check result is sent to the control section 60.

The control section 60 compares the check result of the face information by the second identification section, and the check result of the first identification section. When both pieces of the face information are determined to be identical to the person who has previously been registered (the second identification has succeeded), the person is allowed to pass through, and operations of steps S267 and S268 are performed. On the other hand, when the face information from the second identification section, and the face information from the first identification section are not determined to be identical to the person who has previously been registered (the second identification has failed), the person is not allowed to pass through, and operations of steps S2611 to S2614 are performed. This can prevent a third person from entering and passing through the gate apparatus 101 immediately after the identification of the previously registered person by the first identification section, i.e., illegal entry by “impersonation.”

As described above, in the case where the second identification section is configured to check the person by an ID card, or a pin number, intentional “impersonation” by a person who borrowed the card, or obtained the pin number may be possible. Therefore, the best identification by the second identification section is biometric identification free from these possibilities. In this embodiment, the camera 9 is used as the second identification section to perform the face identification. Thus, the number of persons in the gate apparatus 1 can be checked. Accordingly, when two or more persons are found in the gate apparatus, their passage is not allowed (the second identification has failed). This can prevent the tailgating with more reliability.

In this case, in the gate apparatus 101, the first to eighth sliding shutters 10a to 10h are opened when the control section 60 receives the information that the identification has succeeded, thereby forming a passageway which leads the person to the part of the exit where the person should be guided to. Thus, the person can pass through without stopping. Also in this example, the face identification unit 64 as the second identification section performs the face identification using the camera 9 at the exit in a period from when the person passes the first sliding shutter 10a to when the person passes the third sliding shutter 10c. Thus, the travel of the person is not interrupted. The face identification unit 64 as the second identification section performs the identification by taking an image of the traveling person using the camera 9 at a distance from the person. Thus, the person does not have to stop for the identification. This allows the identification in the gate apparatus without interrupting the travel of the person.

When a determination is made that the second identification has succeeded in step S266, the procedure waits for the exit sensor 51 to turn from on to off in step S267. When the exit sensor 51 is turned from on to off, a determination is made that the person has passed through the gate apparatus 101. Then, all the sliding shutters 10a to 10h are closed in step S268, and the output of the light emitting member 42 is stopped, or the light of the light emitting member is changed to the standby color to return to the standby state in step S269.

When a determination is made that the second identification has failed in step S266, i.e., when a determination is made that the person who has passed the third sliding shutter 10c cannot proceed forward anymore, the seventh and eighth sliding shutters 10g and 10h are closed in step S2611, thereby preventing the travel of the person. P273 in FIG. 27 shows the state.

In step S2612, the light emitted from the light emitting member 42 is changed from green to red, thereby informing the person that the person has to return to the entrance.

In step S2613, the control section waits for the first passage detection sensor 11a to turn from on to off. When the first passage detection sensor 11a is turned from on to off, the procedure proceeds to step S2614, and a determination is made that the person has left the gate apparatus after a lapse of the predetermined time from when the first passage detection sensor 11a is turned from on to off. Then, the first to sixth sliding shutters 10a to 10f are closed to return to the standby state P271 shown in FIG. 27.

After the person has normally traveled through steps S267 and S268, or after the person who is not allowed to pass through has returned to the entrance to return to the standby state through steps S2611 to S2614, the output of the light emitting member 42 is stopped, or the color of the light is changed to the standby color in step S269.

Referring to FIGS. 29 and 30, the control procedure and operation according to a second operation example of the gate apparatus 101 installed according to the first installation example will be described along a flowchart of FIG. 28.

In this operation example (the second operation example), the sliding shutters (the open/close members 10) are opened/closed to restrict an area around the person traveling in the gate apparatus 101 to form defined space, and a path through which the defined space is moved is adjusted in such a manner that the defined space is moved from the vicinity of the entrance to the predetermined position near the exit. Thus, the moving defined space is used as the passageway to control the direction of the person traveling the gate apparatus 101. This can naturally guide the person to the predetermined exit position without interrupting the smooth travel of the person. The defined space restricting the area around the person is moved from the vicinity of the entrance to the vicinity of the exit, thereby preventing the “tailgating” by two or more persons who attempt to enter simultaneously.

In this example, the gate apparatus 101 is kept in the standby state P291 shown in FIG. 29 until the human detection sensor 14 detects the person standing in front of the entrance identification section 8 in step S281 of the control procedure shown in FIG. 28.

When the human detection sensor 14 of the entrance identification section 8 detects the person approaching in step S281, the entrance identification section 8 obtains data of the person's palmprint and face in step S282, and checks the obtained data against the previously registered data for identification (to identify whether the person is a registered person). When the identification has succeeded, the person is identified, and the part of the exit (the right or left exit) is determined based on the exit information previously stored in correspondence with the information for identifying the person (to which of the right and left exits divided by the exit divider 81 the person should be guided, i.e., whether the person is guided to the exit passageway A or the exit passageway B). The information of the determination is sent to the control section 60 together with the information that the identification has succeeded. The first identification fails when the obtained data does not match with the previously registered data, and the person is not allowed to pass through.

Upon receiving the information that the identification has succeeded, the control section 60 allows the light emitting member 42 to emit green light to turn the side panels 6 green, thereby informing the person that the person can pass through in step S283.

In step S284, the motor 22 for driving the first and second sliding shutters 10a and 10b is driven to open the first to second sliding shutters 10a and 10b to bring the shutters in the state P292 shown in FIG. 29. In this case, the degrees of opening of the first and second sliding shutters 10a and 10b (the degree of opening of the shutter) are adjusted based on the person's shape information. For example, three types of lateral width of the person are registered in advance as the shape information based on the width of the person's shoulder or waist, and a determination is made which one of the three types the obtained shape information is, thereby setting the necessary and sufficient degree of opening of the shutter in accordance with the lateral width.

In step S285, a determination is made whether the first passage detection sensor 11a is turned from on to off to check whether the person has passed the first sliding shutter 10a. When the person enters the gate apparatus 101, the first passage detection sensor 11a arranged between the first sliding shutter 10a and the second sliding shutter 10b to correspond to the first sliding shutter 10a is turned on. As the person travels forward, the first passage detection sensor 11a is turned off. The control section 60 determines that the person has passed the first sliding shutter 10a when the first passage detection sensor 11a is turned from on to off.

When a determination is made that the person has passed the first sliding shutter 10a, operation of opening the third sliding shutter 10c, and closing the first sliding shutter 10a is started in step S286. In this step, as shown in the state P293 in FIG. 29, the first to third sliding shutters 10a to 10c form space only for a single person (defined space), thereby preventing tailgating by another person who attempts to follow the person identified at the entrance. When two persons attempt to enter the defined space, the first sliding shutter 10a cannot be normally closed. Therefore, the illegal entry can be detected.

In step S287, a determination is made whether the second passage detection sensor 11b is turned from on to off to determine whether the person has passed the second sliding shutter 10b. When a determination is made that the person has passed the second sliding shutter 10b, operation of opening the fourth sliding shutter 10d, and closing the second sliding shutter 10b is started in step S288. In this step, as shown in the state P294 in FIG. 29, the second to fourth sliding shutters 10b to 10d keep the space only for a single person (the defined space). The fourth sliding shutter 10d forms an opening which is slightly shifted to the left to which the person should be guided.

In step S289, a determination is made whether the third passage detection sensor 11c is turned from on to off to determine whether the person has passed the third sliding shutter 10c. When a determination is made that the person has passed the third sliding shutter 10c, operation of closing the third sliding shutter 10c is started in step S2810. At this time, the fifth sliding shutter 10e is not opened yet, and the gate remains in the state P295 in FIG. 29.

Then, in step S2811, identification is performed by the face identification unit 64 as the second identification section (identification using the camera 9 at the exit), and the result is reflected on the subsequent gate control.

The identification by the second identification section (the identification using the camera 9 at the exit) is performed after the person has entered the gate apparatus 101. Face information obtained by the camera 9 is checked against the previously registered information used for the identification by the first identification section (the identification using the camera 13 of the entrance identification section 8), and the check result is sent to the control section 60.

The control section 60 compares the check result of the face identification by the second identification section, and the check result of the first identification section. When both pieces of the face information are determined to be identical to the person who has previously been registered (the second identification has succeeded), the person is allowed to pass through, and operation of step S2812 is performed. On the other hand, when the face information from the second identification section and the face information from the first identification section are not determined to be identical to the person who has previously been registered (the second identification has failed), the person is not allowed to pass through, and operations of step S2813 to S2816 are performed. This can prevent a third person from entering and passing through the gate apparatus 101 immediately after the identification of the previously registered person by the first identification section, i.e., illegal entry by “impersonation.”

In this gate apparatus 101, the first to fourth sliding shutters 10a to 10d are sequentially opened in accordance with the travel of the person as shown in the states P291 to P295 in FIG. 29 in a period from when the person passes the first sliding shutter 10a to when the person passes the third sliding shutter 10c, thereby sequentially moving the defined space in the traveling direction. Thus, the person can pass through the gate without stopping. Also in this example, the face identification unit 64 as the second identification section performs face identification using the camera 9 at the exit, and the identification is started immediately after the person has passed the first sliding shutter 10a, and an image of the traveling person is taken by the camera 9 at a distance from the person. Thus, the person does not have to stop for the identification, thereby allowing the second identification in the gate apparatus 101 without interrupting the travel of the person.

When a determination is made that the second identification has succeeded in step S2811, the control section 60 sequentially opens the fifth to eighth sliding shutters 10e to 10h in step S2812 as shown in the states P296 to P298 in FIG. 29, thereby moving the defined space toward the exit. Thus, the person is allowed to pass the fifth to eighth sliding shutters 10e to 10h to travel to the predetermined exit.

In this way, as shown in the states P292 to P298 in FIG. 29, the defined space only for the single person is moved from the entrance to the left of the exit divider 81 as the person travels. Specifically, the opening/closing of the sliding shutters 10a to 10h is controlled to adjust the movement path of the defined space, thereby guiding the person to the predetermined part of the exit.

When a determination is made that the second identification has failed in step S2811, i.e., when a determination is made that the person who has passed the third sliding shutter 10c as shown in the state P301 of FIG. 30 cannot proceed forward anymore, the color of the light emitted by the light emitting member 42 is changed from green to red to inform the person that the person cannot pass through in step S2813.

In step S2814, the first to third sliding shutters 10a to 10c behind the traveling person are all opened as shown in the state P302 in FIG. 30, thereby allowing the person to return to the entrance.

In step S2815, the procedure waits for the first passage detection sensor 11a to turn from on to off Then, when the first passage detection sensor 11a is turned from on to off, the procedure proceeds to step S2816, and a determination is made that the person has left the gate apparatus after a lapse of the predetermined time from when the first passage detection sensor 11a is turned from on to off. Then, the first to eighth sliding shutters 10a to 10h are all closed to return to the standby state P291 shown in FIG. 29.

After the person has normally traveled through step S2812, or after the person who is not allowed to pass through has returned to the entrance to return to the standby state through steps S2813 to S2816, the output of the light emitting member 42 is stopped, or the color of the light is changed to the standby color in step S2817.

### (Second Installation Example of Gate Apparatus)

FIG. 31 shows a second installation example of the gate apparatus 101. In the above-described installation example shown in FIG. 25 (the first installation example), the left part of the exit of the gate apparatus 101 is connected to the exit passageway A, and the right part of the exit of the gate apparatus 101 is connected to the exit passageway B to guide the person to one of the two directions based on the previously registered information. However, as shown in FIG. 31, the authorized person may be guided to one of the directions (the exit passageway A), and the unauthorized person may be guided to a return passageway 82 (the second installation example). In this example, only the information for identifying the person (face information, palmprint information, fingerprint information, etc.) and the shape information are used, but the exit information about the exit to which the person should be guided is not used.

In this example, the gate apparatus 101 controls the sliding shutters 10a to 10h in such a manner that the person who is identified by the first and second identifications is guided to a part of the exit connected to the exit passageway A (a part of the exit on the left of the exit divider), while the person who is identified by the first identification, but is not identified by the second identification is guided to a part of the exit connected to the return passageway 82 (a part of the exit on the right of the exit divider 81).

In this case, the return passageway 82 is formed to extend to the entrance of the gate apparatus 101, thereby sending the person who is guided to the right of the exit divider 81 back to the entrance of the gate apparatus 101 through the return passageway 82.

In order to prevent illegal entry through the return passageway 82, a return gate 83 which is opened/closed in response to the control of guiding the person to the return passageway 82 by the gate apparatus 101 may be provided. The return gate 83 is configured to open/close only once toward the entrance after the person is guided to the return passageway 82, thereby preventing the illegal entry. The return gate 83 may be a gate which opens when it detects that the person approaching from the return passageway 82 to the vicinity of the entrance.

Thus, the person who is determined as a person who is not allowed to pass through in the gate apparatus 101 would not go back in the gate apparatus 101, and does not prevent the entry of the next person. Further, since the person does not go back within the gate apparatus 101, the number of sliding shutters can be increased to allow successive entry of a plurality of persons to the gate apparatus.

### (Third Installation Example of Gate Apparatus)

FIG. 32 shows a third installation example of the gate apparatus 101. As shown in FIG. 32, the exit divider 81 is removed from the gate apparatus 101, and the width of the gate apparatus 101 is increased. A part of the exit of the gate apparatus 101 is connected to an exit passageway A, and the other part is connected to an exit passageway B so as to guide the person to one of the two directions based on the previously registered information. When the person is not allowed to pass through, the person is guided to a return passageway 82.

In this case, the control is different from that of the second installation example only in that one of three parts of the exit is selected. The control is the same as that of the second installation example in that the positions of the openings formed by the sliding shutters 10a to 10h are adjusted in such a manner that the passageway or the movement path of the defined space is guided toward the selected part of the exit.

As shown in the installation example of FIG. 32, the exit divider 81 is not an essential component. If a division wall not included in the gate apparatus 101 is provided near the sliding shutter 10 at the exit of the gate apparatus 101, the person can reliably be guided to the intended part of the exit from the passageway or the defined space.

1. A gate apparatus comprising:
a shape information obtaining section which is configured to obtain information about a shape of a person; and
a restriction section which is configured to restrict at least forward and rearward travel of the person traveling from an entrance to an exit of a passageway in the gate apparatus to form space defined within the passageway, and is capable of adjusting a shape of the defined space based on the shape information of the individual person obtained by the shape information obtaining section.

2. The gate apparatus of claim 1, wherein
the restriction section is capable of adjusting a lateral dimension of the defined space orthogonal to a traveling direction of the person, and is capable of adjusting the shape of the defined space by adjusting the lateral dimension.

3. The gate apparatus of claim 1, wherein
the restriction section is capable of adjusting a front-back dimension of the defined space parallel to the traveling direction of the person, and is capable of adjusting the shape of the defined space by adjusting the front-back dimension.

4. The gate apparatus of claim 1, wherein
the restriction section is capable of moving the defined space in the traveling direction of the person while substantially keeping the shape of the defined space determined based on the shape information of the individual person.

5. The gate apparatus of claim 1, wherein
the restriction section includes three or more open/close members which are arranged along the passageway, and slide across the passageway to open/close the passageway, and is capable of changing the shape of the defined space by adjusting the degrees of opening of the open/close members.

6. The gate apparatus of claim 1, wherein
the restriction section includes four or more open/close members which are arranged along the passageway, and slide across the passageway to open/close the passageway, and is capable of changing the shape of the defined space by adjusting the degrees of opening of the open/close members located in the middle of the passageway in the traveling direction of the person.

7. The gate apparatus of claim 6, wherein
the restriction section is capable of moving the defined space in the traveling direction of the person by sequentially opening/closing the open/close members arranged along the passageway.

8. The gate apparatus of claim 1, further comprising:
a first identification section which is configured to identify the person before entering the defined space, wherein
the gate apparatus allows the person to pass through when the first identification section identifies that the person is authorized to pass through.

9. The gate apparatus of claim 8, further comprising:
a second identification section which is configured to identify the person who is traveling the passageway in accordance with the movement of the defined space.

10. The gate apparatus of claim 1, wherein
the restriction section is configured to restrict lateral movement of the person traveling the gate apparatus relative to the traveling direction of the person to form a specified passageway extending from the entrance to a part of the exit, and
the gate apparatus further comprises an adjustment section which is configured to adjust the shape of the specified passageway by driving and controlling the restriction section, thereby connecting the specified passageway to a predetermined part of the exit.

11. The gate apparatus of claim 2, wherein
the restriction section is capable of adjusting a front-back dimension of the defined space parallel to the traveling direction of the person, and is capable of adjusting the shape of the defined space by adjusting the front-back dimension.

12. The gate apparatus of claim 2, wherein
the restriction section is capable of moving the defined space in the traveling direction of the person while substantially keeping the shape of the defined space determined based on the shape information of the individual person.

13. The gate apparatus of claim 3, wherein
the restriction section is capable of moving the defined space in the traveling direction of the person while substantially keeping the shape of the defined space determined based on the shape information of the individual person.

14. The gate apparatus of claim 11, wherein
the restriction section is capable of moving the defined space in the traveling direction of the person while substantially keeping the shape of the defined space determined based on the shape information of the individual person.
